(19) United States
(12) Patent Application Publication
(10) Pub. No.: US 2005/0027697 A1
(43) Pub. Date: Feb. 3, 2005

(54) Generalized data handler

(76) Inventors: Tom Cheng, Fremont, CA (US); Peter J. Neumayer, Sunnyvale, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/632,563

(22) Filed: Jul. 31, 2003

(51) Int. Cl. G06F 7/00

(52) U.S. Cl. 707/3

(57) ABSTRACT

Systems and techniques to provide data in a generalized data format. In a commercial transaction environment, a generalized data handler may access business object data. The business object data may include attribute data for one or more attributes of a desired commercial transaction. The generalized data handler may retrieve metadata from the business object data, and may construct a generalized data structure for the attribute data using the metadata. The generalized data handler may parse the attribute data into the generalized data structure, which may then be exported to an external application.

### BACKGROUND

The present application describes systems and techniques relating to data processing using a generalized data format.

It may be difficult to share data among data processing environments. This difficulty may be particularly problematic in an electronic commerce environment, where parties to potential commercial transactions generally do not operate in the same data processing environment. For example, in an electronic commerce application in which a purchaser wishes to purchase goods or services from a supplier, each company would ideally be able to access, exchange, and analyze data using its existing computer systems. However, the purchaser and potential suppliers may each use different systems (e.g., different applications and/or platforms) to process commercial transaction data.

In some circumstances, data may be exchanged between different systems using a generalized data format, such as XML (Extensible Markup Language). In XML, users create customized tags (commands inserted in a document that specify how the document, or a portion of the document, should be formatted) that enable the definition, transmission, validation, and interpretation of data among applications.

Data may be exchanged among different applications (e.g., from a purchaser's Enterprise Resource Planning or ERP system to a supplier's different ERP system) using a method called data marshalling. In data marshalling, data is gathered and transformed into a generalized format such as XML. The generalized data may then be communicated to another system and converted into a format compatible with that system. However, data marshalling generally requires that the structure of the data to be marshaled be pre-defined. That is, parameters such as a name, data type, and field size for each component of the data to be exported generally need to be known so that a data structure can be pre-defined prior to retrieving and marshalling data. Thus, existing marshalling systems may provide limited flexibility for exchanging data among systems.

### SUMMARY

In general, in one aspect, a systems and techniques described herein may be used to implement a method, which may include retrieving data such as business object data from one or more data storage elements, such as database tables. The business object data may include attribute data, where the attribute data is associated with an attribute of a desired or completed commercial transaction.

Metadata may be retrieved from the business object data. The metadata may include a name, a data type, and a value for each attribute of the business object data. The metadata may further include an indicator to indicate whether the attribute is a static attribute or a dynamic attribute.

A generalized data structure may be constructed using the metadata. For example, a data structure conforming to XML format may be constructed using the metadata. The attribute data may be parsed into the generalized data structure, as may other data of the business object data. The attribute data in the generalized data structure may be communicated to one or more external applications.

The business object data may include opportunity header data and/or opportunity listing data. Opportunity header data may include general information about a desired commercial transaction. For example, opportunity header data may include an opportunity identifier (e.g., an opportunity ID or opportunity name), an opportunity type, and opportunity classification, an opportunity start date, an opportunity end date, a desired currency type, and the like. Opportunity listing data may include data related to products and services that are the subject of the desired commercial transaction. For example, the opportunity listing data may include a product name, desired quantity, product type, service name, service type, and the like.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIG. 1 is a conceptual diagram of a structure for dynamic bidding tool data, according to an embodiment.

FIG. 2 is a flowchart showing an embodiment of a process for exporting data in a generalized form.

FIG. 3 is a generalized data handler sequence diagram, according to an embodiment.

FIGS. 4A and 4B are sequence diagrams showing detail of the Construct Opportunity operation shown in FIG. 3, according to an embodiment.

FIGS. 5A and 5B are sequence diagrams showing detail of the Construct XML operation shown in FIG. 3, according to an embodiment.

FIGS. 6A and 6B are sequence diagrams showing details of the To XML operation shown in FIG. 3, according to an embodiment.

FIG. 7A is an XML listing for a static attribute, according to an embodiment.

FIG. 7B is an XML listing for a number of static attributes, according to an embodiment.

FIG. 8 are class diagrams for business object classes, according to an embodiment.

FIGS. 9A and 9B are block diagrams of embodiments of systems for implementing a dynamic bidding tool.

FIG. 10 is a diagram of an embodiment of a user interface for a dynamic bidding tool.

FIGS. 11A and 11B are diagrams of an embodiment of a user interface for creating an opportunity.

FIG. 12 is a diagram of an embodiment of a user interface for creating a line item for an opportunity.

FIG. 13 is a diagram of an embodiment of a user interface for setting up an invitation list.

FIG. 14 is a diagram of an embodiment of a user interface for a potential supplier.

FIG. 15 is a diagram of an embodiment of a user interface for submitting a bid on an opportunity.

FIG. 16 is a diagram of an embodiment of a user interface for winner determination.

Like reference symbols in the various drawings indicate like elements.

### DETAILED DESCRIPTION

The systems and techniques described herein relate to a generalized data handler that may be used to exchange data among data processing systems. Although the implementations described below use extensible markup language (XML) as the generalized format to exchange data, other formats such as Standard Generalized Markup Language (SGML) may be used.

As noted above, systems and techniques for exchanging data among different systems may be particularly useful in electronic commerce. In the description below, the generalized data handler is described with reference to a dynamic bidding tool, which refers to a software-implemented system allowing potential parties to commercial transactions to interact via electronic systems such as computer networks.

The dynamic bidding tool allows users, such as purchasing agents, to create data objects including data related to a desired commercial transaction. The data objects may be referred to as “opportunities,” and the associated data may be referred to as opportunity data. A purchasing agent may create the opportunity by accessing the dynamic bidding tool via a user interface displayed on the user's computer, and entering opportunity data via the user interface.

The system may generate the user interface to obtain data related to a standard set of attributes via standard data fields in the user interface. The standard set of attributes may be referred to as “static attributes” of the opportunity. Static attribute data may include data such as an opportunity start date, opportunity end date, opportunity type, opportunity classification, product type, product quantity, product base unit, and the like. Alternately, the user (or a system administrator) may add an additional data field or other object that is not included in each opportunity (such as an attachment or a hyperlink to related information) to the opportunity, where the object or the opportunity data corresponding to the additional data field may be referred to as a “dynamic attribute” of the opportunity. Dynamic attribute data may include data such as a product data sheet attachment, a substitute parts list, company-, industry-, or technology-specific data, and the like.

A generalized data handler as described herein may allow data from the dynamic bidding tool to be provided to a purchaser's or supplier's system in a generalized form. Since the data is in generalized form, it may be used by many different types of external applications. Additionally, the data structure for transaction data need not be pre-defined, so users have considerable flexibility in the opportunity data that may be provided to the supplier through the use of dynamic attributes.

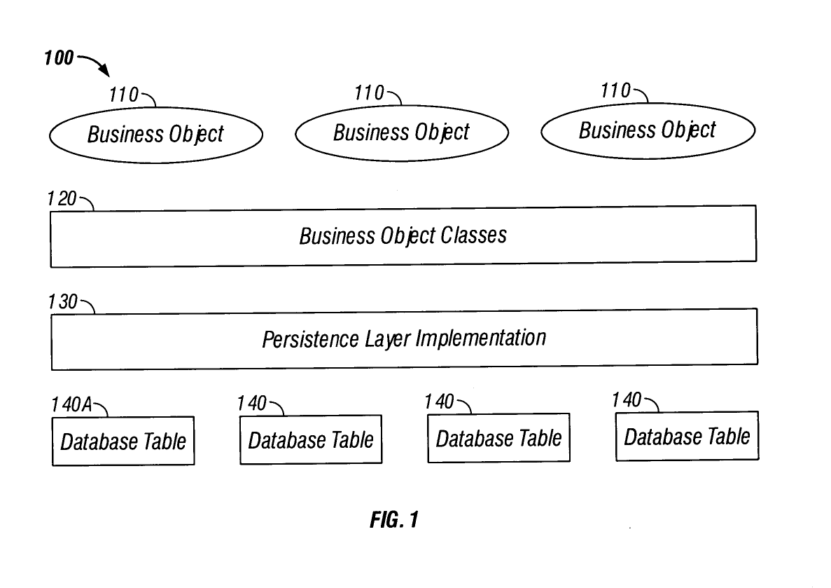

FIG. 1 shows a conceptualized structure 100 for a accessing dynamic bidding tool data using a generalized data handler, according to some implementations. Business objects 110 represent, for example, opportunities and responses to opportunities in the dynamic bidding tool (although the generalized data handler may be used with other types of business objects). Each business object 110 may include attribute data for one or more associated static attributes and one or more associated dynamic attributes, as described more fully below.

Business object data is stored in one or more database tables 140. In some implementations, data for different business objects may be stored in a particular database table 140. For example, database table 140A may be a header table, and may store header data for a number of business objects. Business object classes 120 may access data in database tables 140 via a persistence layer implementation 130. In some implementations, the persistence layer is implemented using Structured Query Language (SQL). Business object classes 120 may be Java classes to retrieve and manipulate business object data stored in database tables 140.

Each business object 110 includes metadata defining the data structure of the business object. For example, for each static and dynamic attribute of a particular business object, the business object includes metadata indicating the attribute name, data type, field size, and an indication of whether the attribute is a static attribute or a dynamic attribute. The business object may include many other types of metadata, including whether the attribute is mandatory or optional, and whether the attribute is a display-only attribute.

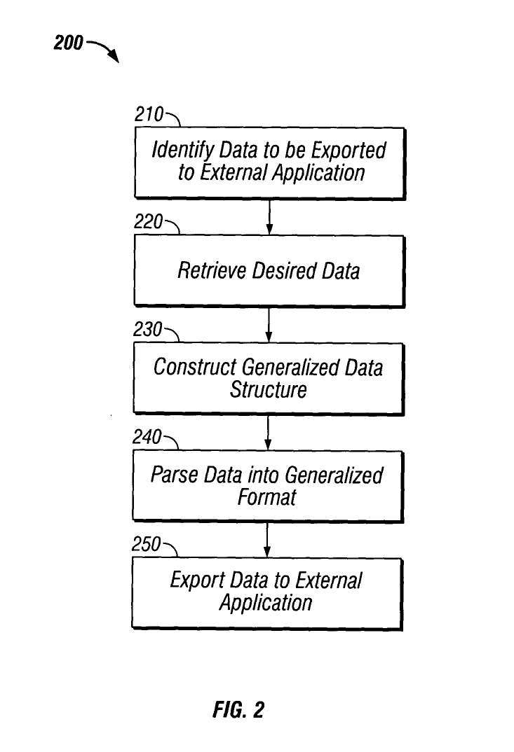

FIG. 2 shows a method 200 that may be used with a structure such as structure 100 of FIG. 1 to exchange business information between a dynamic bidding tool and one or more external applications. Data to be exported to an external application is identified (210). For example, data for all opportunities with a closing date in a particular date range may be requested, or one or more particular business objects may be identified by an identifier such as an opportunity ID.

The desired data is retrieved from one or more database tables (220). For example, business object classes 120 of FIG. 1 may retrieve business object data from database tables 140 via the persistence layer implementation 130, as explained more fully below. Next, metadata is retrieved from the business object data and is used to construct a generalized data structure (230). For example, business object classes 120 may retrieve metadata for each attribute in the business object to construct an XML structure for exporting the attribute data to an external application. The data may then be parsed into a generalized format such as XML format (240). The data may then be exported to the external application (250).

A generalized data handler as described above may provide a number of advantages over available systems. For example, when the schema of a business object such as an opportunity is modified (e.g., an additional data field is added), it would generally be necessary to make manual changes to a data handler program to export business object data to other applications. In contrast, the generalized data handler does not require manual changes upon modification of the business object. Instead, the metadata is retrieved from the business object data and used to construct the generalized data structure. A similar benefit arises when industry-specific schema are desired. Rather than requiring different data handler programs for each industry-specific schema, a single generalized data handler uses business object metadata to export the business object data.

Additionally, adding metadata supports type checking of exported data. This may be particularly important where the exported data is read and maintained using programs such as Microsoft Excel, or Internet browser programs. The metadata also facilitates the importing and processing of modified XML files, where a user modifies and maintains the XML file offline using an office tool such as Microsoft Excel.

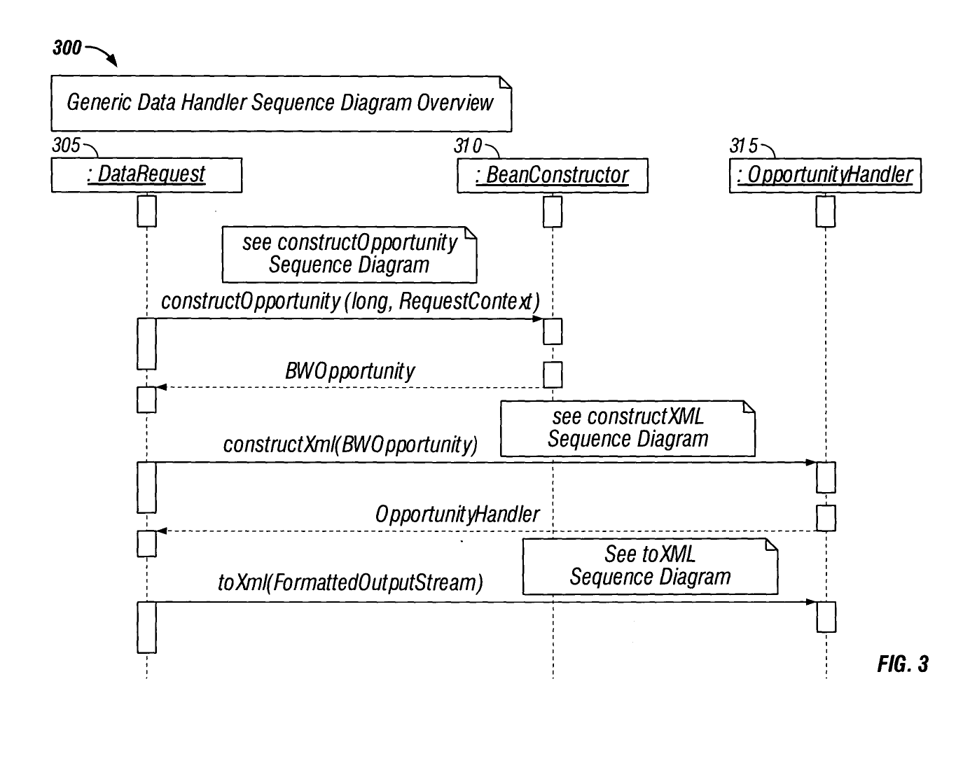

The following describes exemplary systems and techniques that may be used to implement actions such as those shown in FIG. 2. FIG. 3 shows an overview sequence 300 where generalized data handling is implemented using Java classes. Sequence 300 includes a DataRequest class 305, a BeanConstructor class 310, and an OpportunityHandler class 315. DataRequest class 305 may pass one or more opportunity IDs to the other classes for collecting related data objects to be exported to an external application. Related data objects may include opportunity header objects, opportunity listing objects, opportunity multiple quantity objects, response header objects, response listing objects, and response multiple quantity objects.

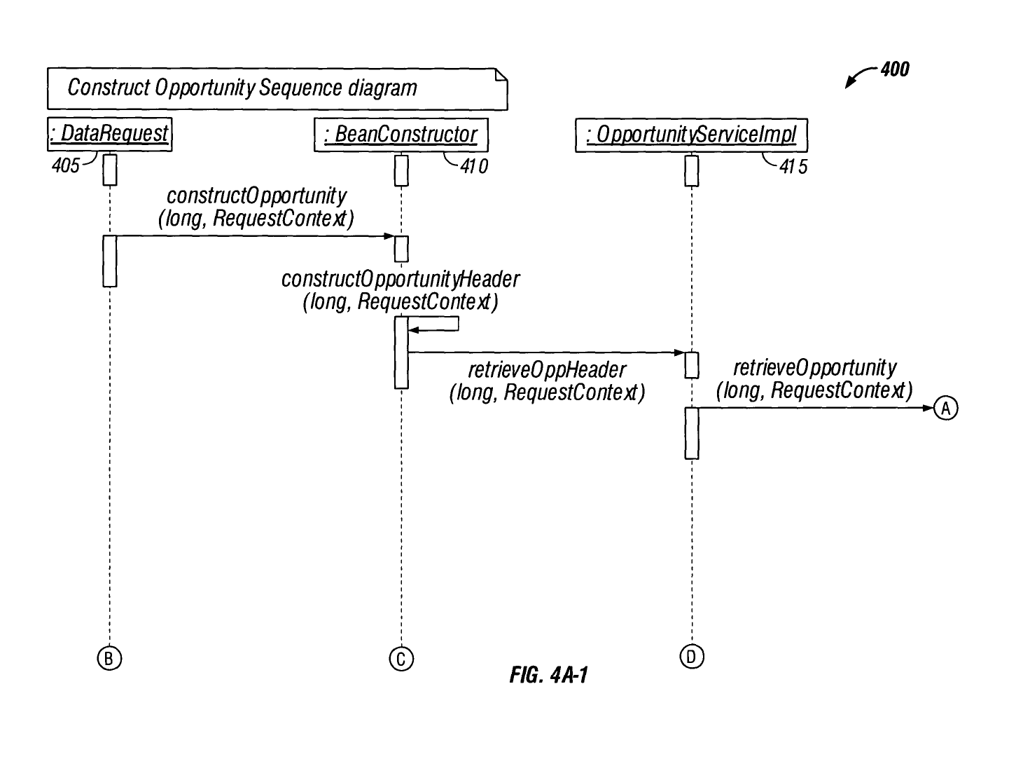

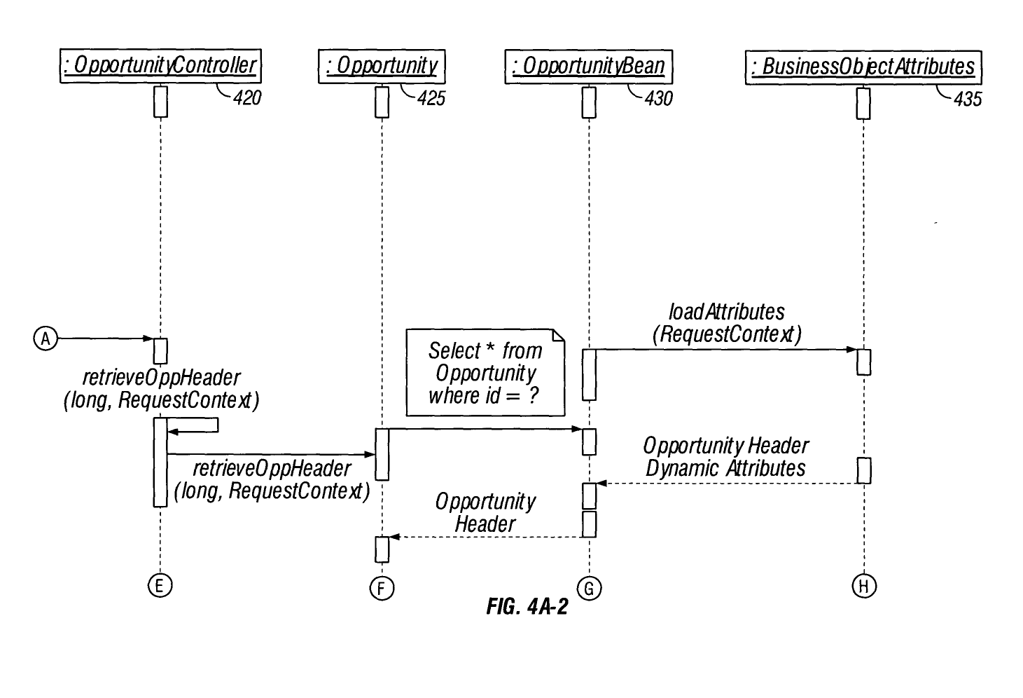

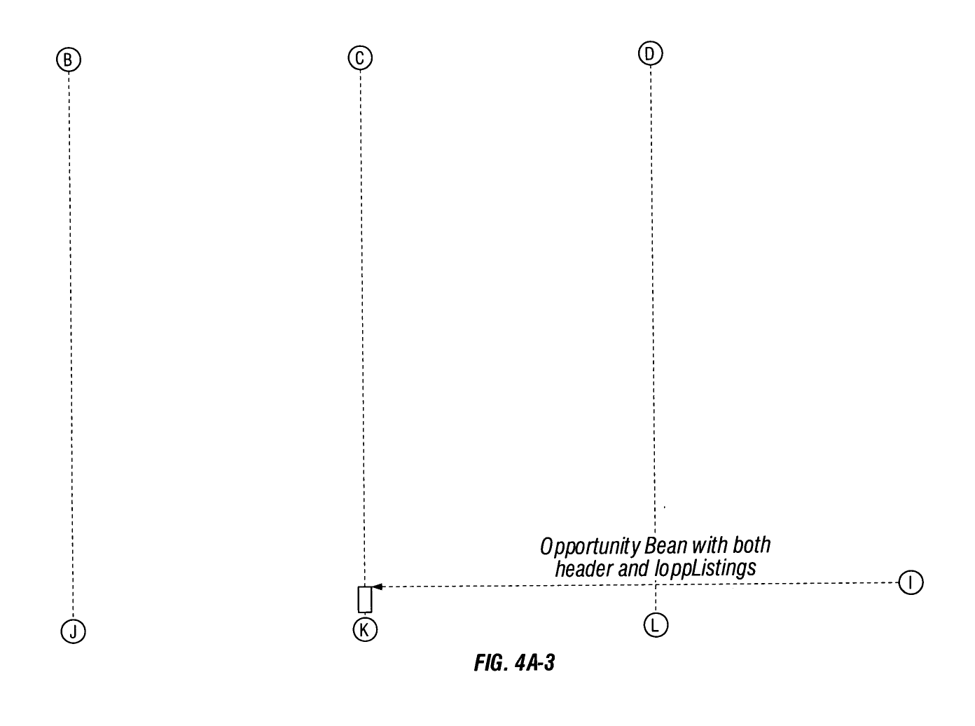

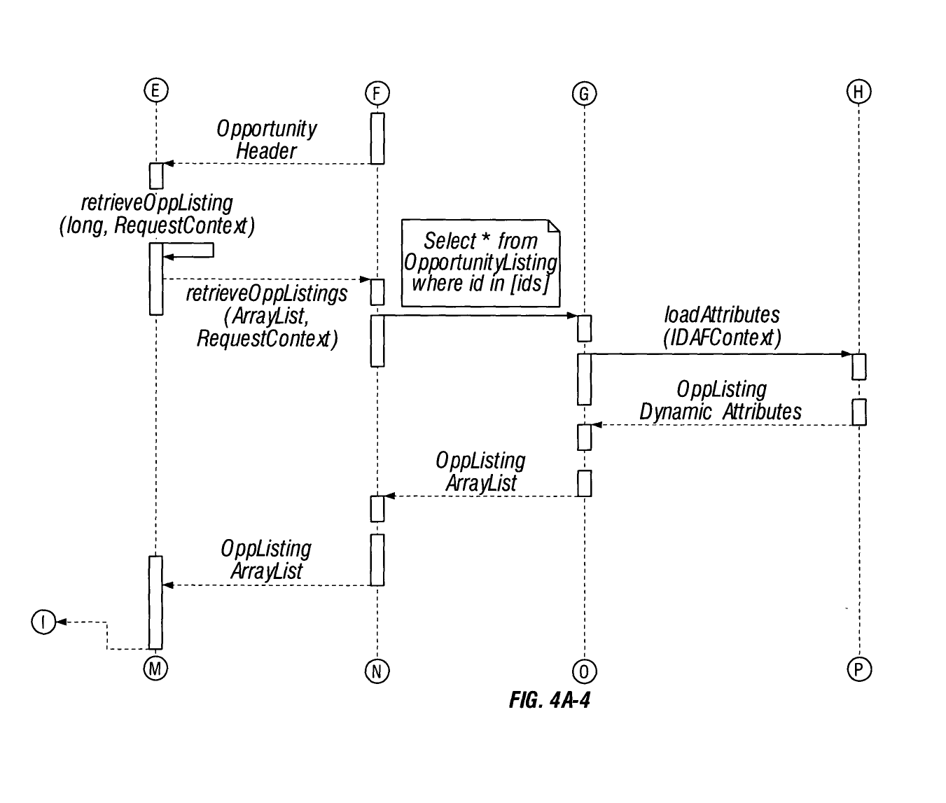

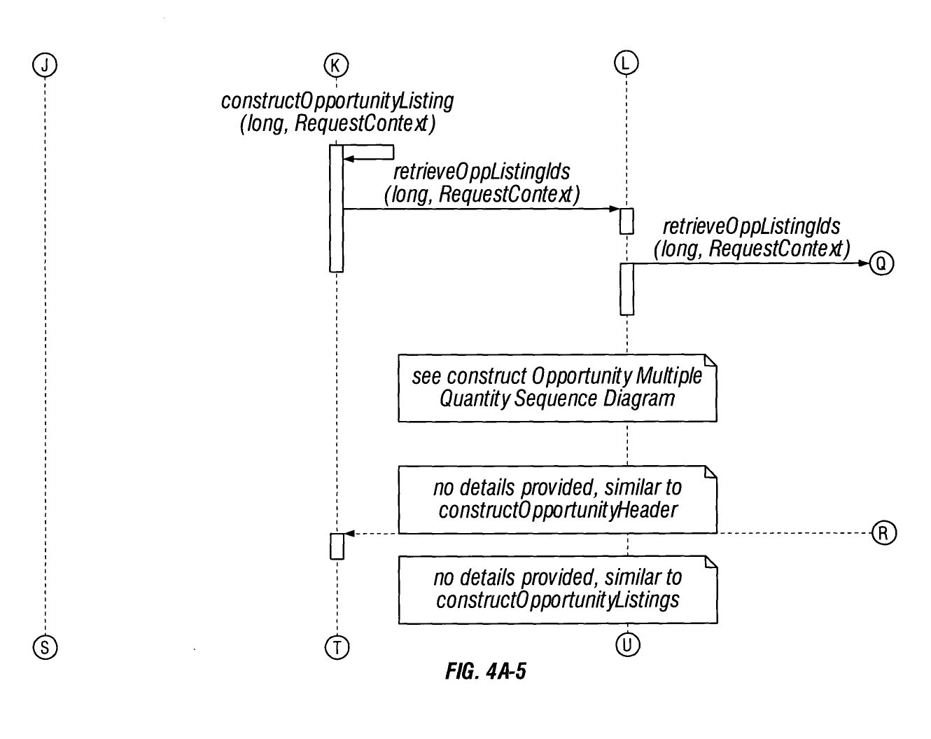

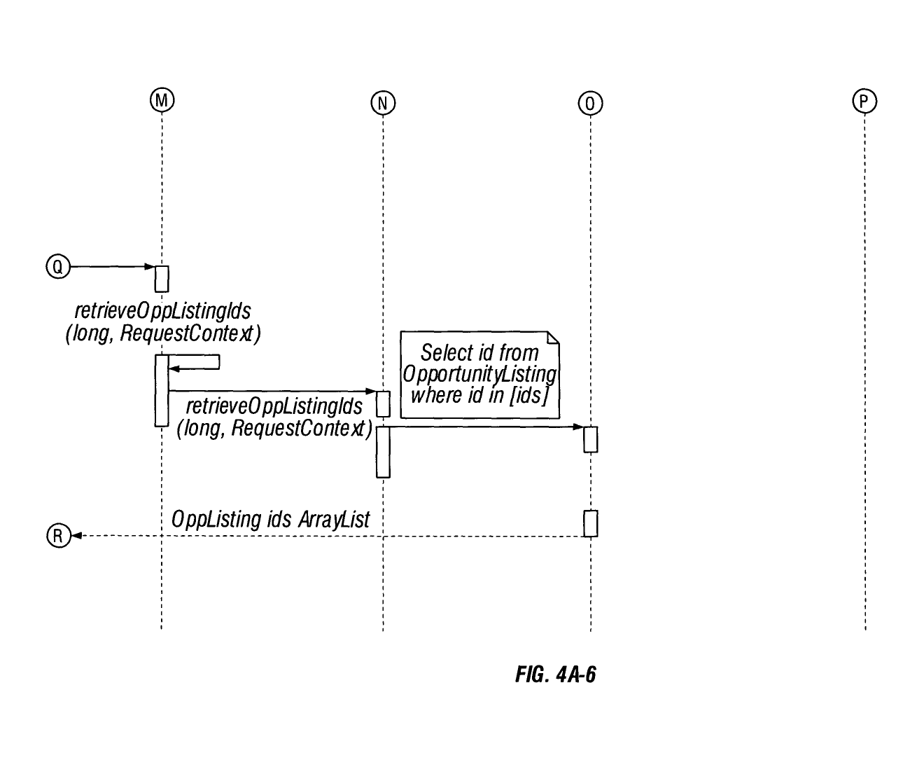

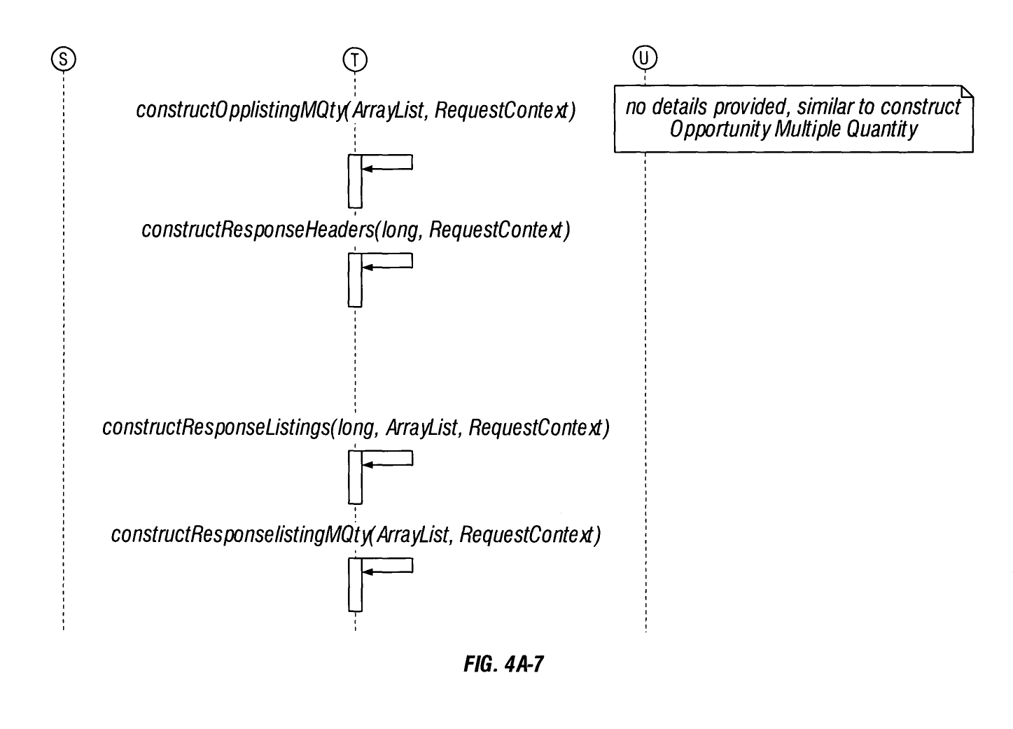

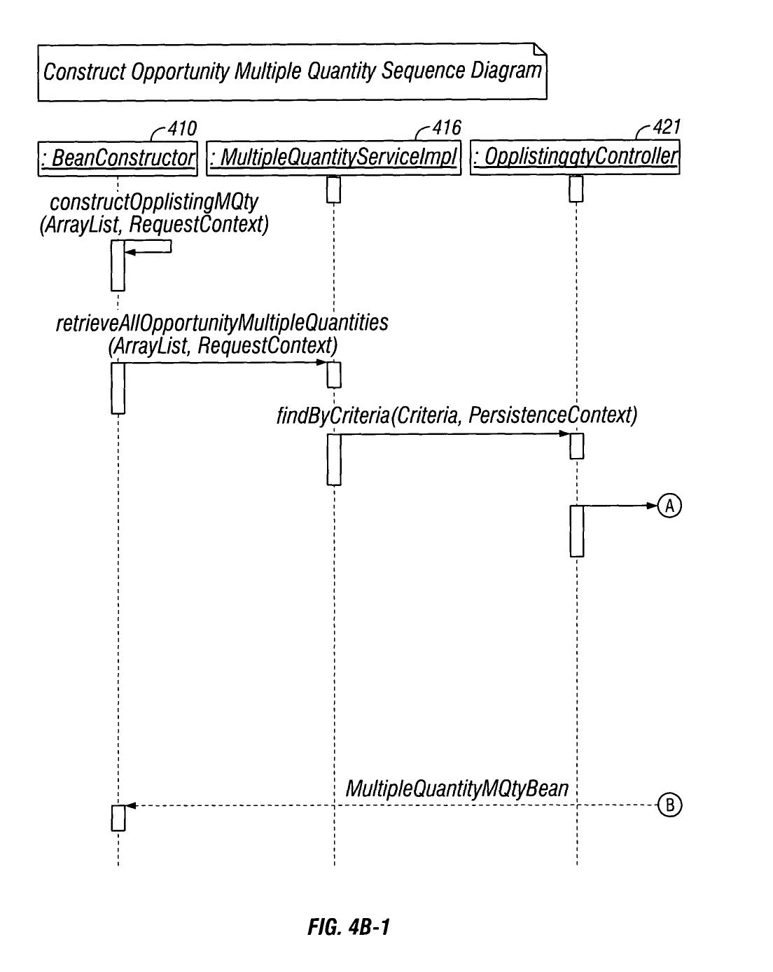

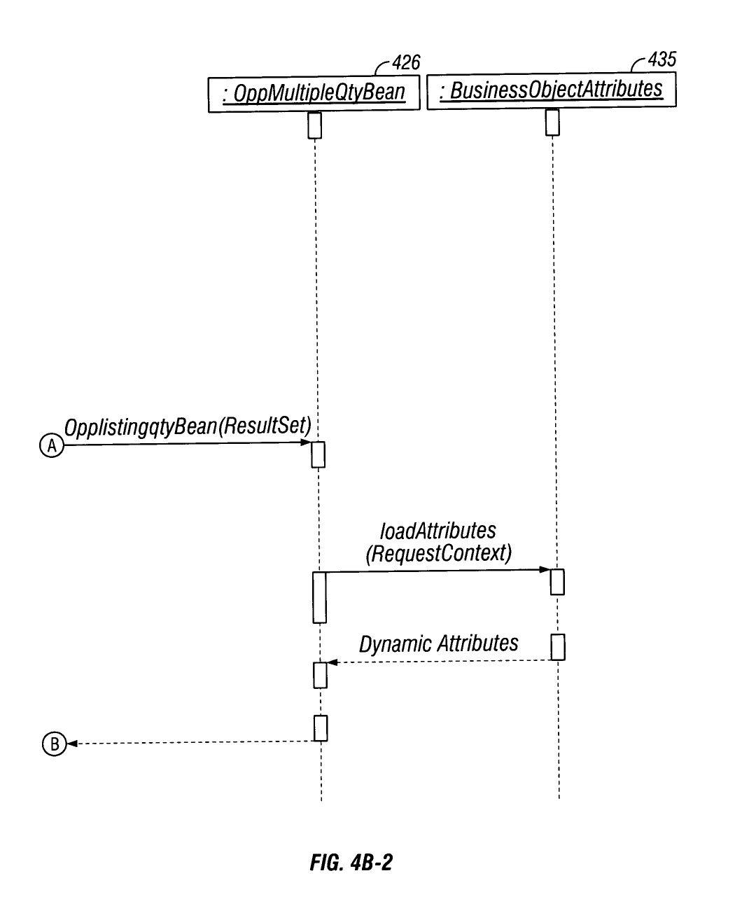

For a particular opportunity, DataRequest class 305 passes a Construct Opportunity request to BeanConstructor class 310. A Construct Opportunity sequence such as the sequence shown in FIGS. 4A and 4B (described below) is implemented to construct the opportunity bean, which includes all data and metadata for the particular opportunity. BeanConstructor class 310 passes the opportunity data to DataRequest class 305.

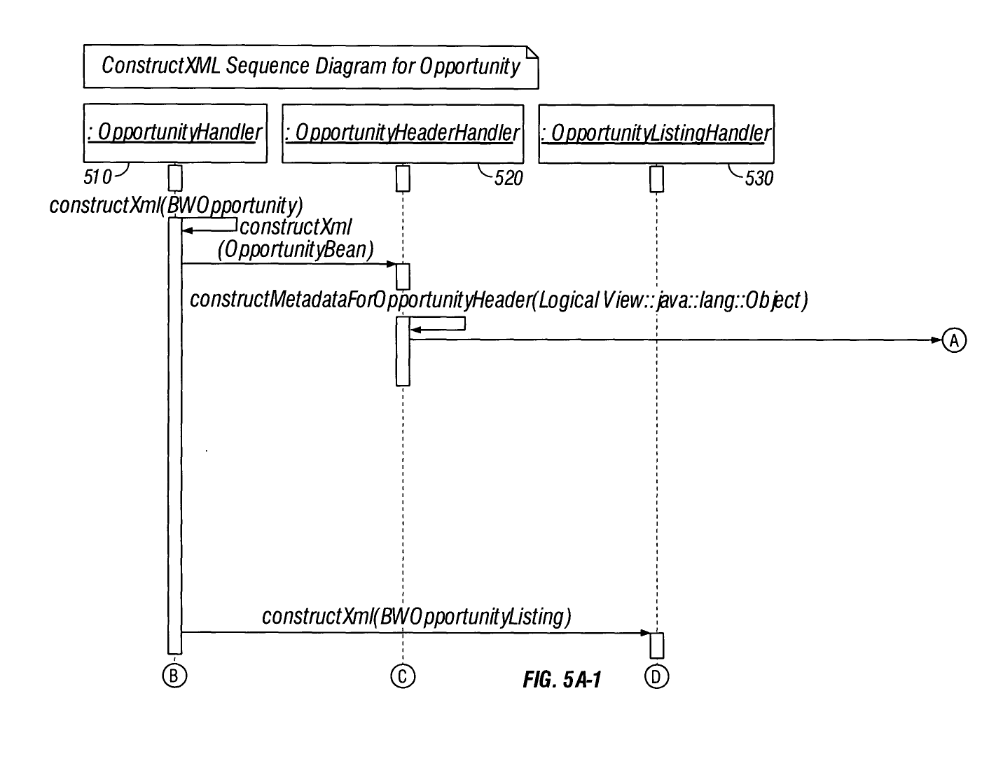

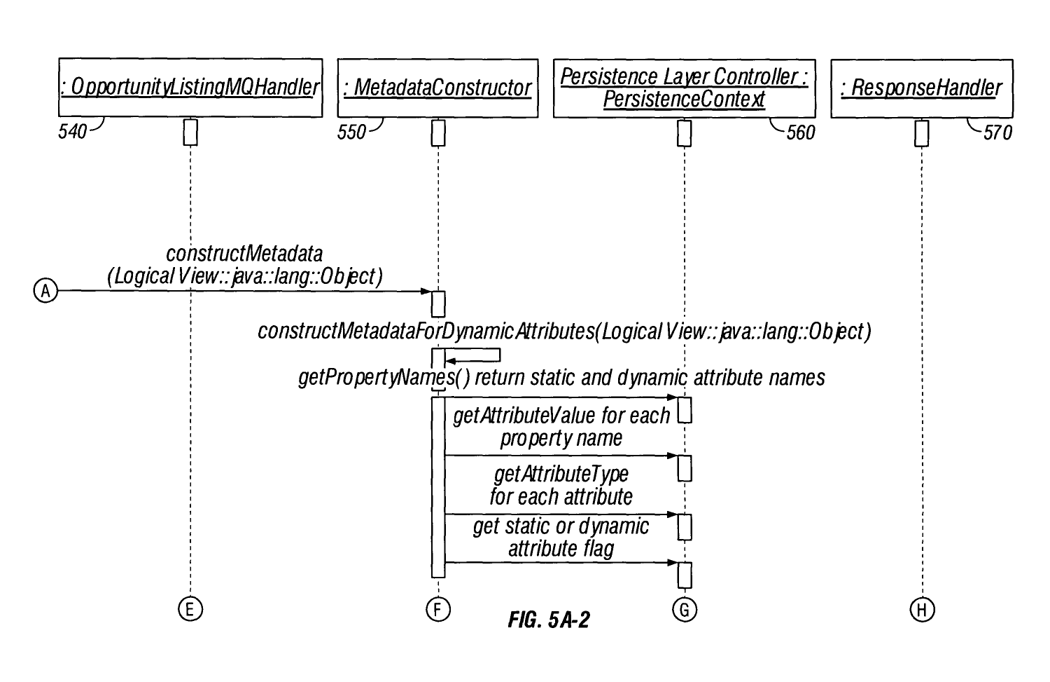

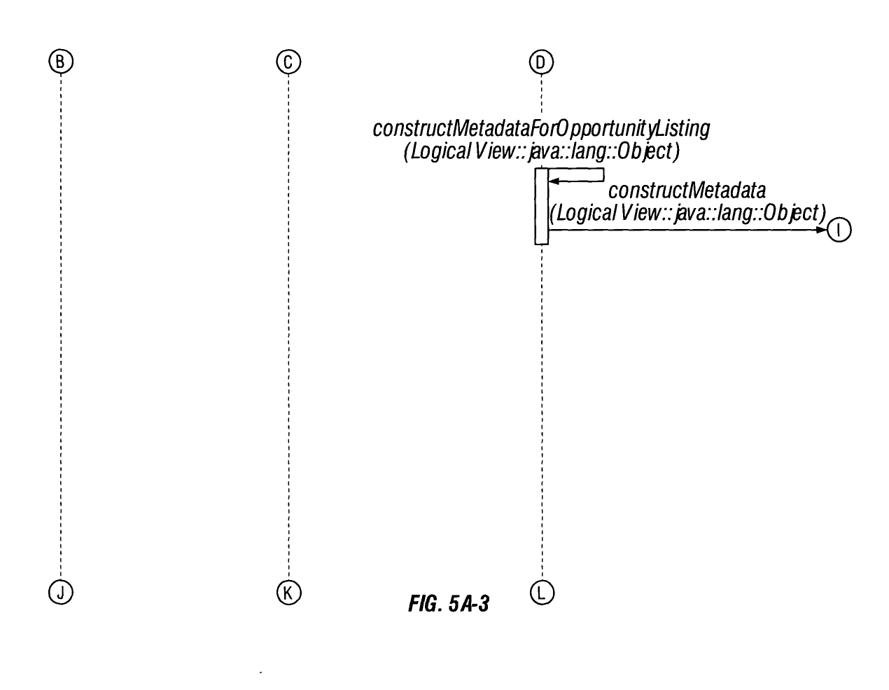

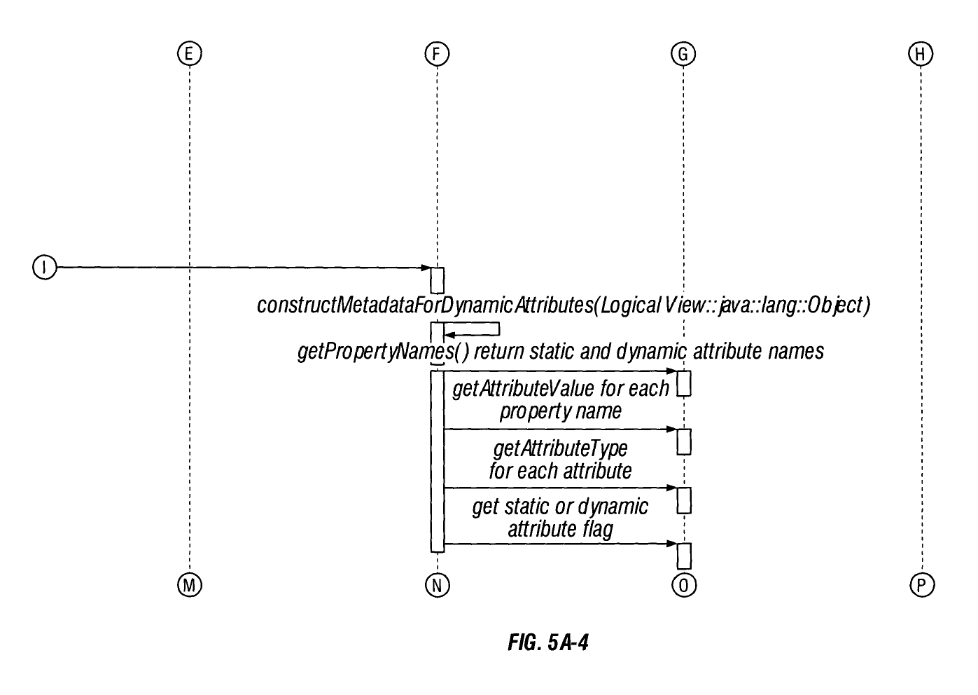

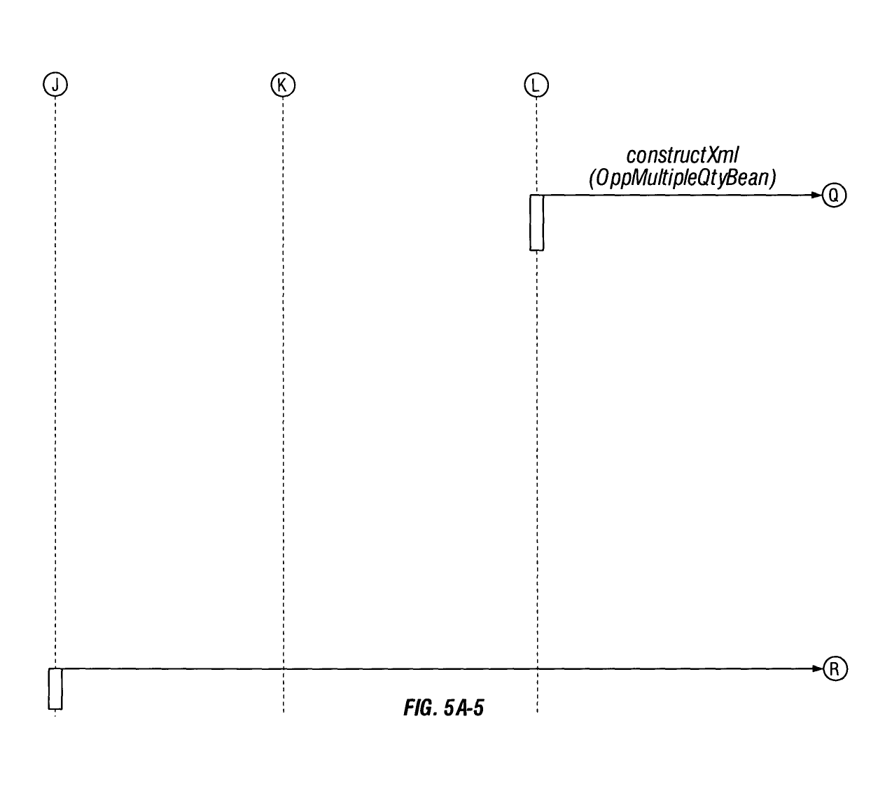

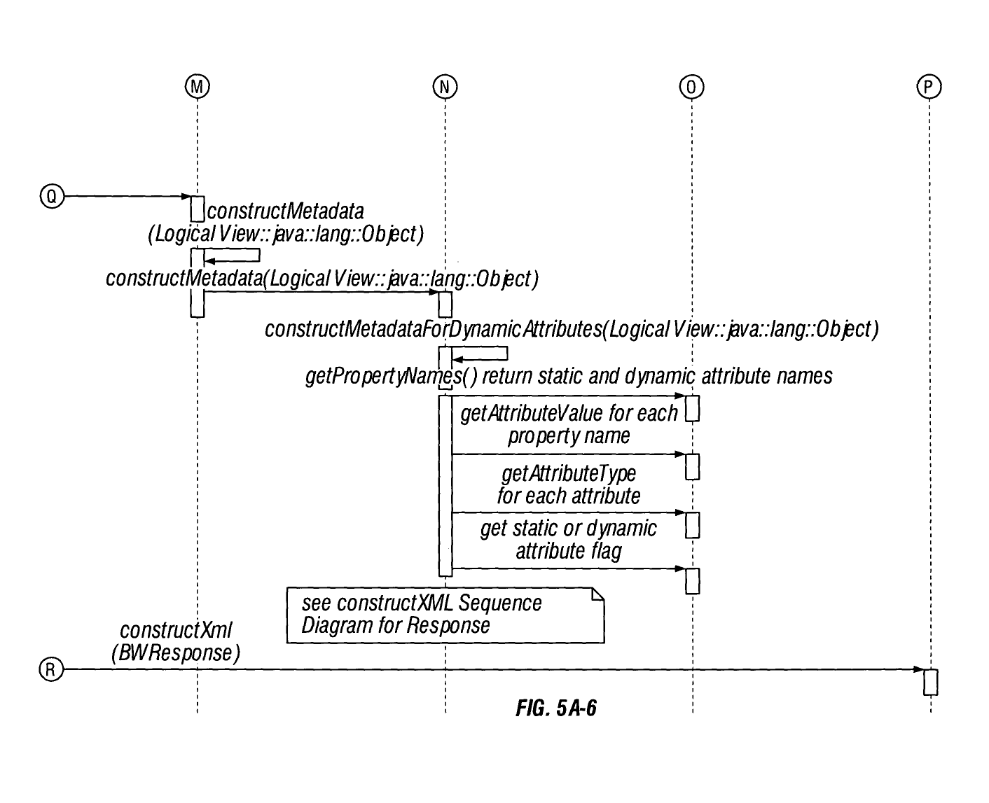

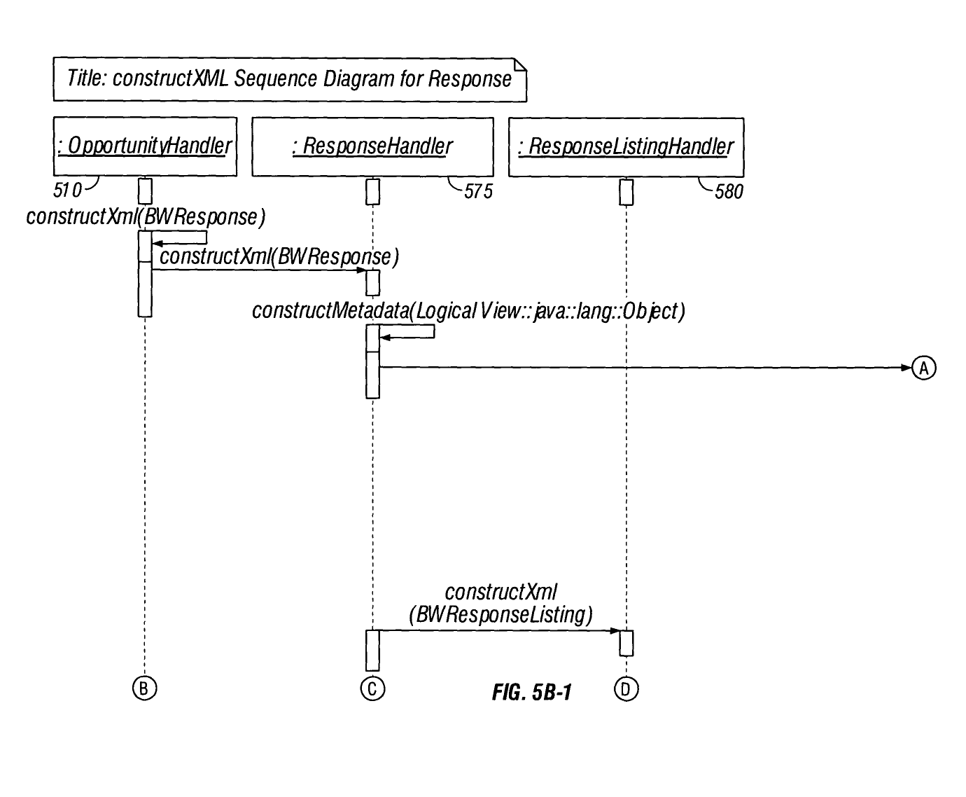

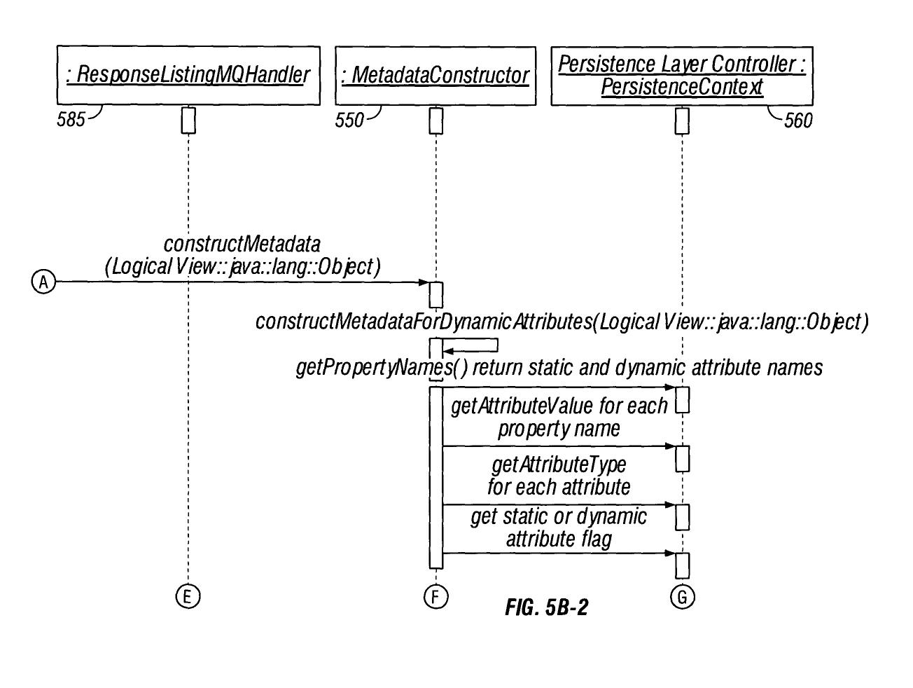

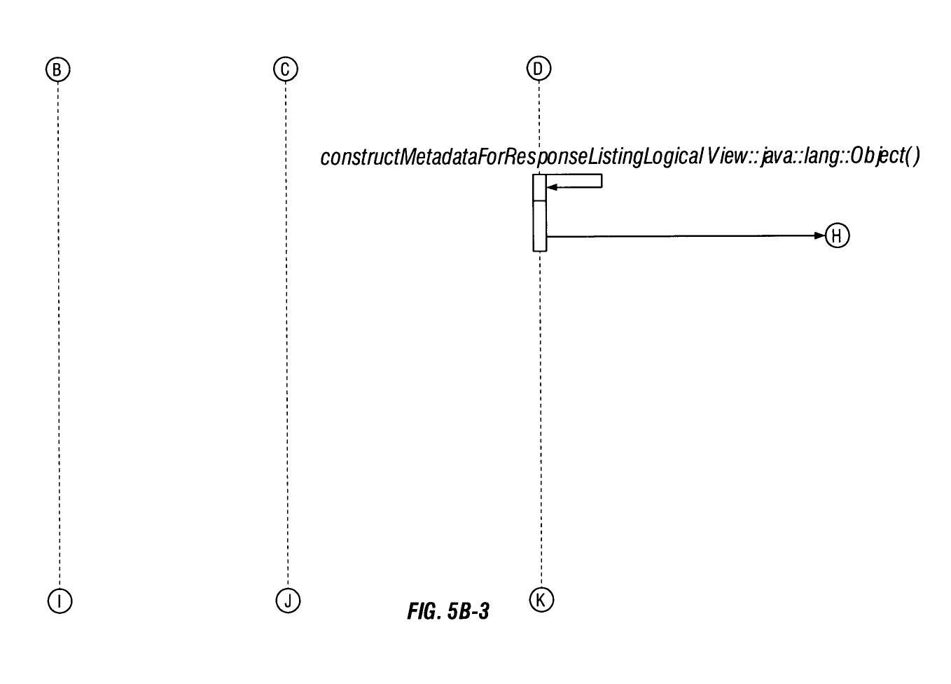

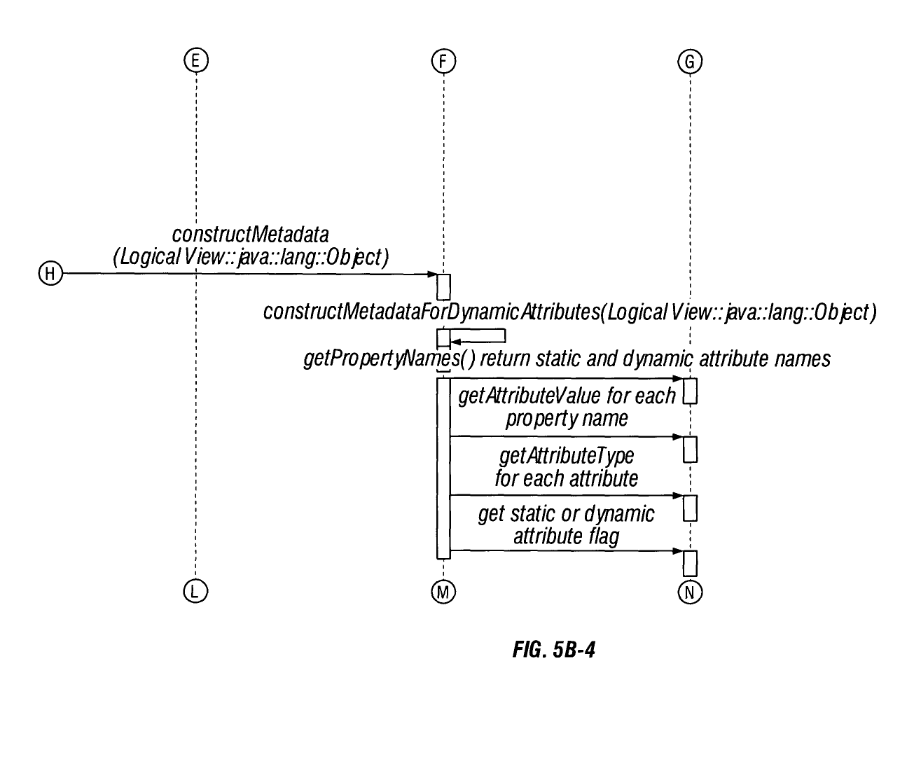

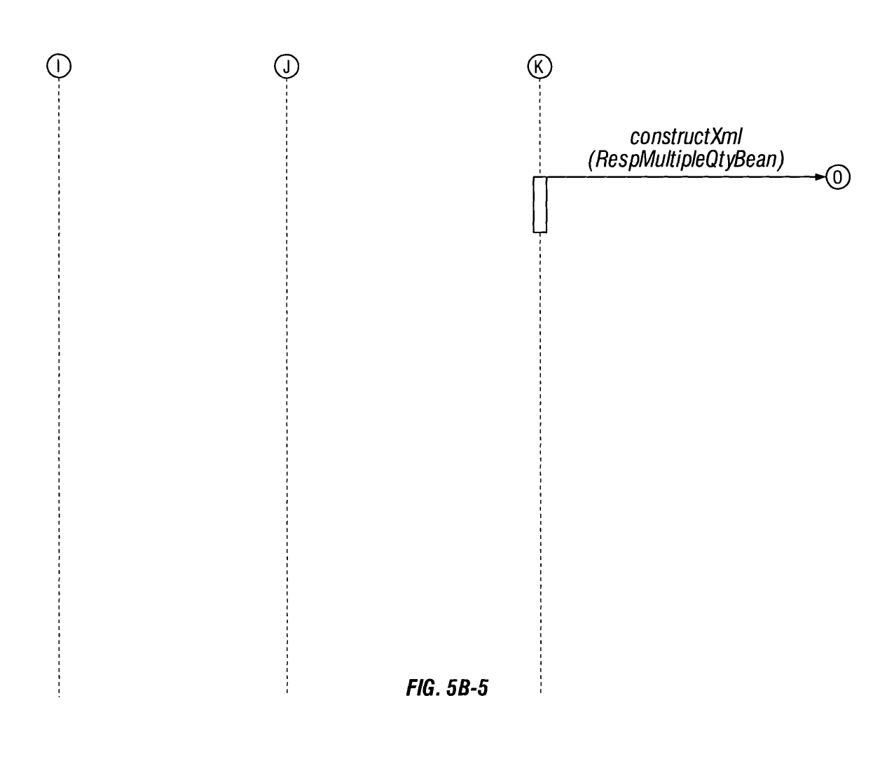

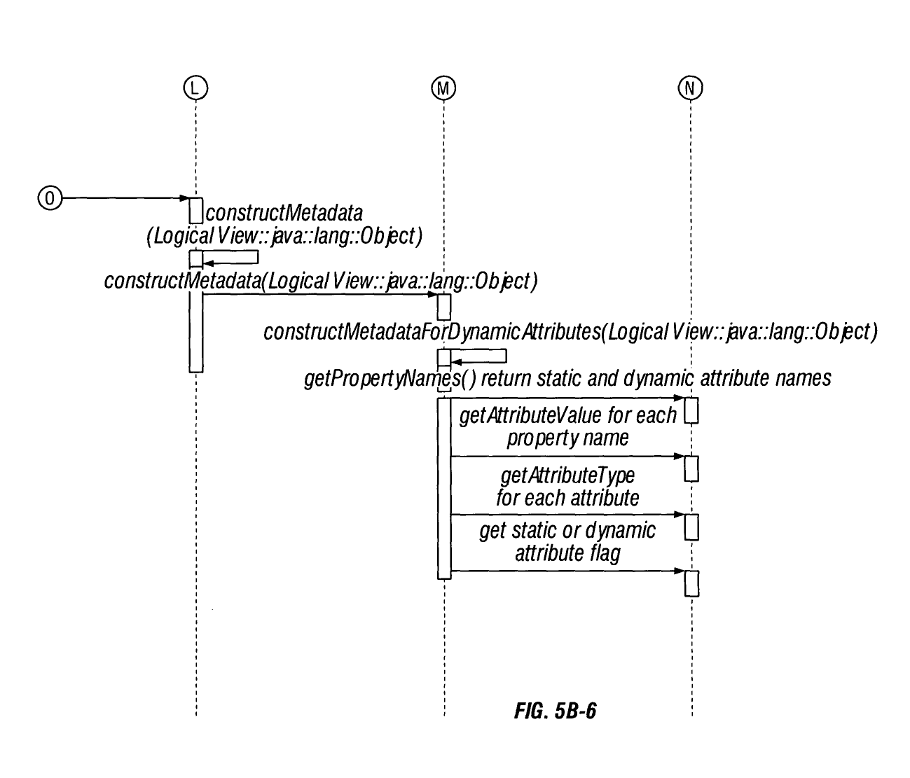

Once the opportunity bean has been constructed, DataRequest class 305 passes a Construct XML request to OpportunityHandler class 315. A Construct XML sequence such as the sequence shown in FIGS. 5A and 5B (described below) is implemented to determine metadata such as the name, type, and value for every attribute in the particular opportunity, as well as to determine whether the attribute is a static attribute or a dynamic attribute. OpportunityHandler class 315 passes the metadata to DataRequest class 305.

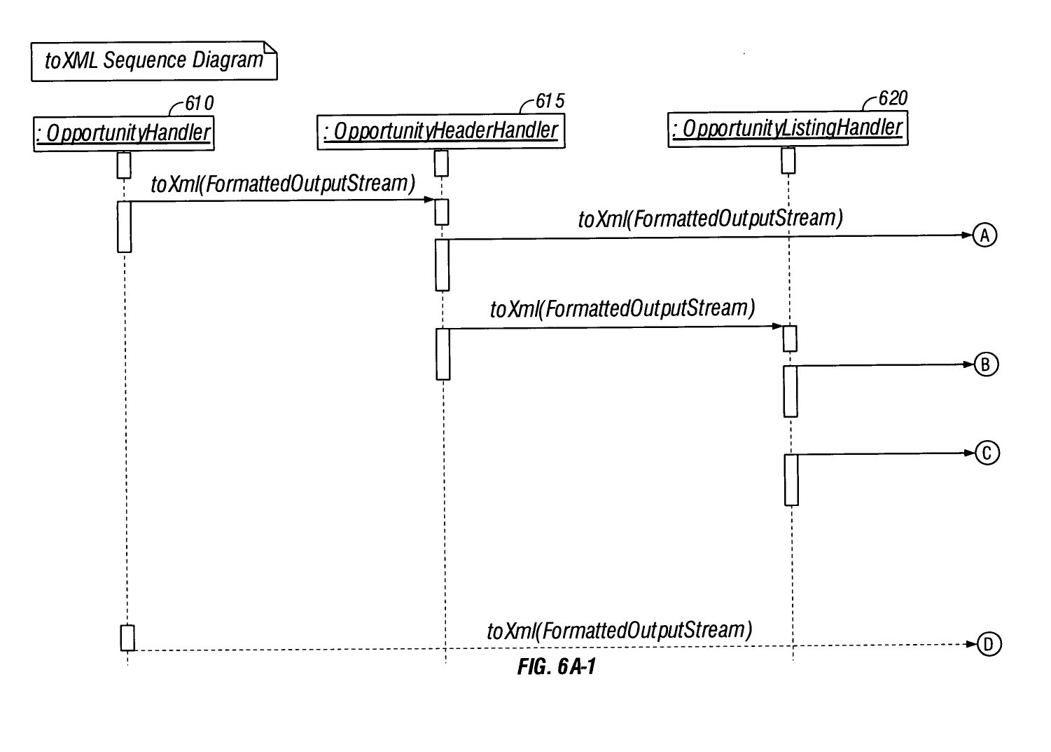

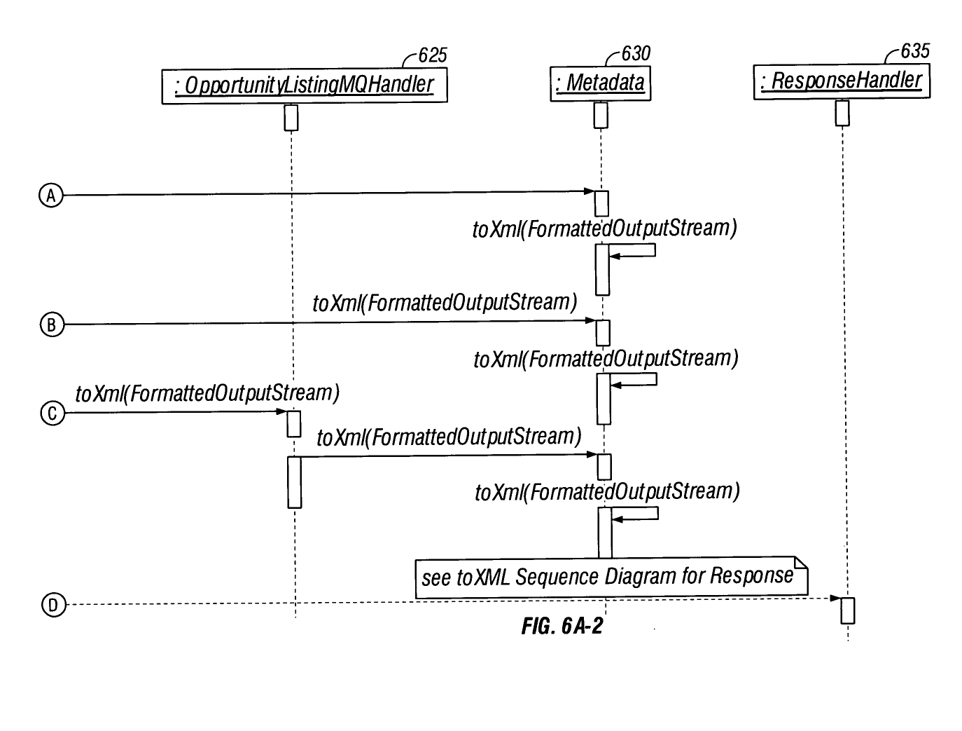

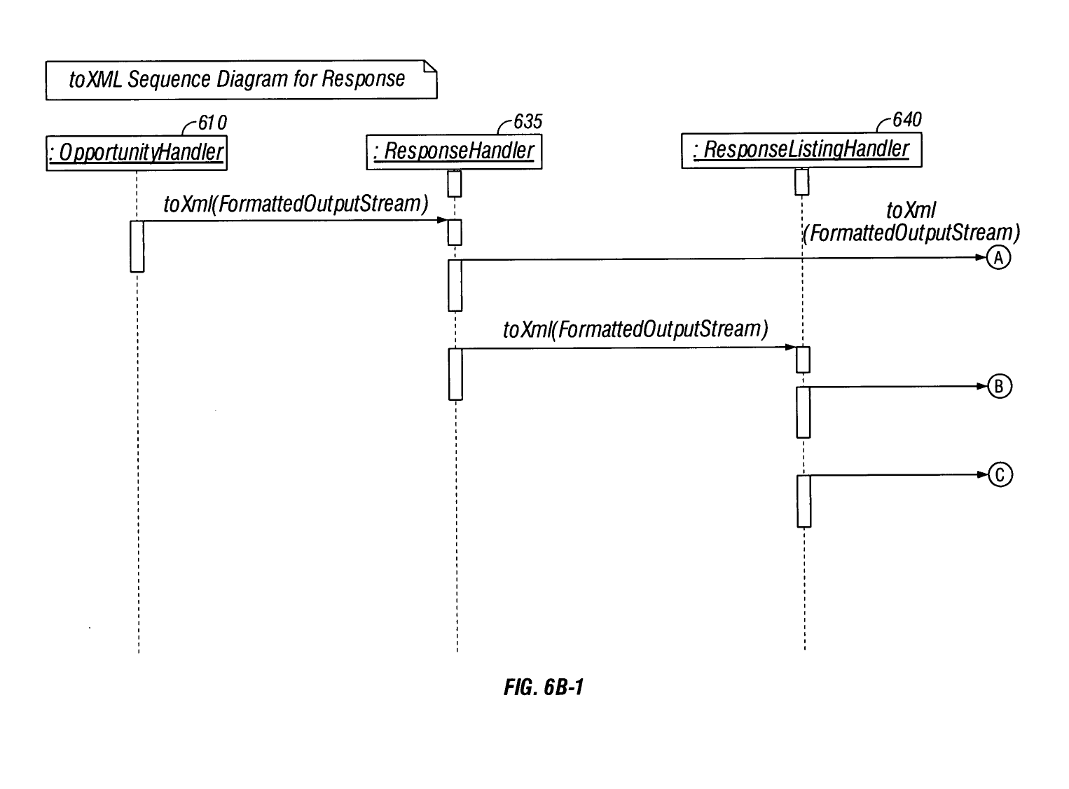

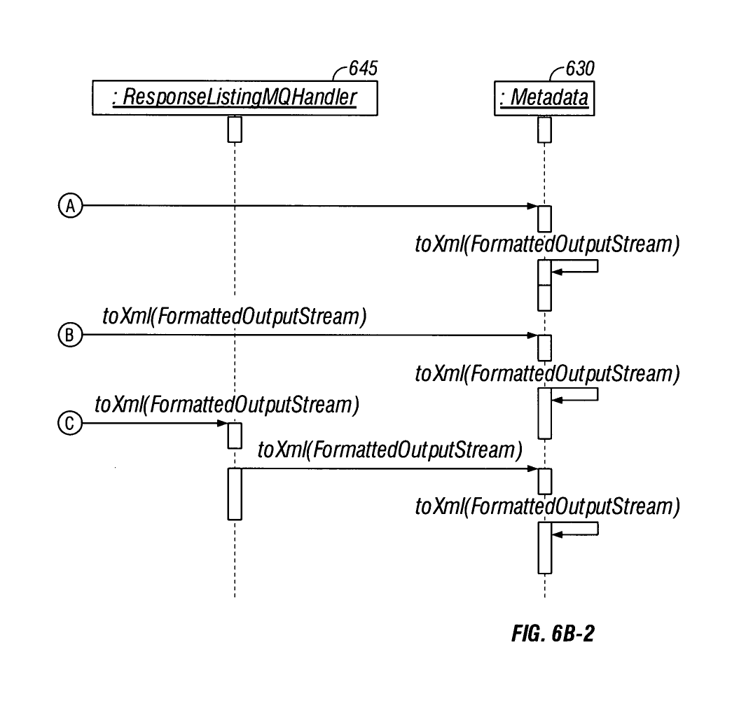

DataRequest class 305 passes a To XML request to OpportunityHandler class 315. A To XML sequence such as the sequence shown in FIGS. 6A and 6B (described below) is implemented to parse opportunity data obtained in the Construct Opportunity sequence into XML format according to the metadata determined during the Construct XML sequence. OpportunityHandler class 315 constructs the XML formatted data for export to the external application.

FIG. 4A shows a Construct Opportunity sequence 400. In order to export data for one or more opportunities to an external application, the opportunity data (including metadata) must be retrieved from, for example, database tables 140 and persistence layer 130 of FIG. 1. A DataRequest class 405 includes an opportunity ID identifying opportunity data to be exported. DataRequest class 405 passes a Construct Opportunity request to a BeanConstructor class 410. In the implementation shown, BeanConstructor class 410 constructs an opportunity header, opportunity listings, and the like separately, although other implementations are possible. Since the process of constructing an opportunity header is generally the same as the process of constructing the rest of the data bean for the opportunity, only the construct opportunity header portion of sequence 400 is described.

BeanConstructor class 410 executes a Construct Opportunity Heading sequence. BeanConstructor class 410 passes a Retrieve Opportunity Header request to a OpportunityServiceImplementation class 415. OpportunityServiceImplementation class 415 passes a Retrieve Opportunity request to an OpportunityController class 420. OpportunityController class 420 executes a Retrieve Opportunity Heading sequence. OpportunityController class 420 passes a Retrieve Opportunity Heading request to an Opportunity class 425. Opportunity class 425 queries an OpportunityBean class 430 to select data for an opportunity with a particular Opportunity ID. OpportunityBean class 435 retrieves the desired data from, for example, one or more database tables, via a BusinessObjectAttributes class 435. Note that the implementation described herein is exemplary only; more, different and/or fewer classes may be used.

Opportunity header data for the opportunity data bean is returned as shown in FIG. 4A. As explained above, data for opportunity listings, opportunity listings (multiple quantities), response headers, response listings, and response listings (multiple quantities) are returned using a similar method to that described above for opportunity header data.

For example, FIG. 4B shows a sequence diagram for constructing an opportunity (multiple quantities) data bean. A particular opportunity may have one or more listings (e.g., different items that a company would like to purchase). Each listing may be for multiple quantities (for example, for a particular listing the desired quantity may be 100 units, and the 100 units may be divided into four shipments of 25 units each). In the exemplary Construct Opportunity sequence shown in FIGS. 4A and 4B, a different algorithm is implemented for listings with multiple quantities. A BeanConstructor class 410 implements a Construct Opportunity Multiple Quantity sequence. BeanConstructor class 410 passes a Retrieve All Opportunity Multiple Quantities request to a MultipleQuantityServiceImplementation class 416. MultipleQuantityServiceImplementation class 416 passes a Find By Criteria request to an OpportunityListingController class 421. OpportunityListingController class 421 passes a request for an Opportunity Listing Multiple Quantity bean to a OpportunityMultipleQuantityBean class 426. OpportunityMultipleQuantityBean class 426 sends a Load Attribute request to a BusinessObjectAttributes class 435, which returns attributes to the OpportunityMultipleQuantityBean class 426. OpportunityMultipleQuantityBean class 425 then returns a Multiple Quantity bean to BeanConstructor class 410.

After a Construct Opportunity sequence such as the sequence illustrated in FIGS. 4A and 4B is completed, a data bean for the desired opportunity has been constructed. In order to export opportunity data to external applications, metadata is subsequently retrieved from the data bean. FIG. 5A shows an example of a Construct XML sequence that may be used to retrieve metadata for exporting opportunity data in XML form. An OpportunityHandler class 510 implements a Construct XML sequence. OpportunityHandler class 510 sends a Construct XML request to an OpportunityHeaderHandler class 520, which implements a Construct Metadata for Opportunity Header sequence. OpportunityHeaderHandler class 520 passes a Construct Metadata request to a MetadataConstructor class 550.

MetadataConstructor class 550 implements a Construct Metadata for Dynamic Attributes sequence. MetadataConstructor class 550 requests property names, attribute values, attribute types, and a static or dynamic attribute flag from a PersistenceLayerController class 560. Similarly, metadata for opportunity listings and opportunity listings (multiple quantities) is retrieved using an OpportuntyListingHandler class 530, an OpportunityListingMQHandler class 540 as shown in FIG. 5A. Response metadata is retrieved using a ResponseHandler class 570.

FIG. 5B shows the Construct XML sequence for responses. OpportunityHandler class 510 executes a Construct XML sequence for the response. OpportunityHandler class 510 passes a Construct XML request to a ResponseHandler class 575. ResponseHandler class 575 executes a Construct Metadata sequence. ResponseHandler class 575 issues a Construct Metadata request to MetadataConstructor class 550, which requests property names, attribute values, attribute types, and a static or dynamic attribute flag from a PersistenceLayerController class 560. Similarly, metadata for response listings and for response listings (multiple quantities) is retrieved using a ResponseListingHandler class 580 and a ResponseListingMQHandler class 585.

Once the metadata has been retrieved, the data may be placed in XML form. FIGS. 6A and 6B show a To XML sequence that may be used to format the data. An OpportunityHandler class 610 executes the To XML sequence by accessing an OpportunityHeaderHandler class 615, an OpporunityListingHandler class 620, an OpportunityListingMQHandler class 625, a Metadata class 630, and a ResponseHandler class 635. FIG. 6B details the response portion of the To XML sequence. To format response data for the opportunity, OpportunityHandler class 610 accesses ResponseHandler class 635, a ResponseListingHandler class 640, a ResponseListingMQHandler class 645, and Metadata class 630.

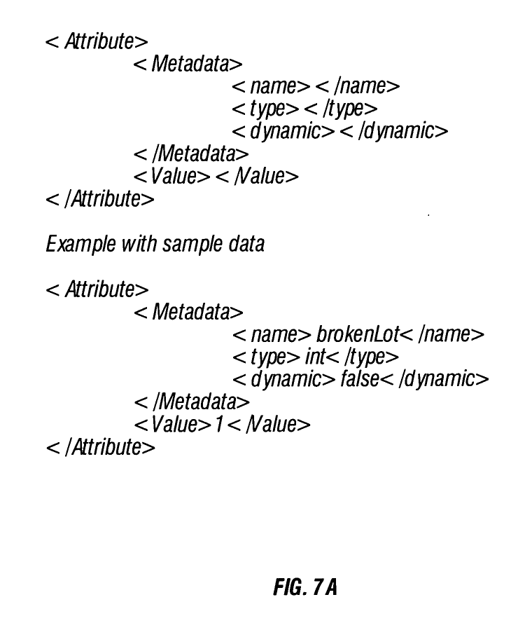

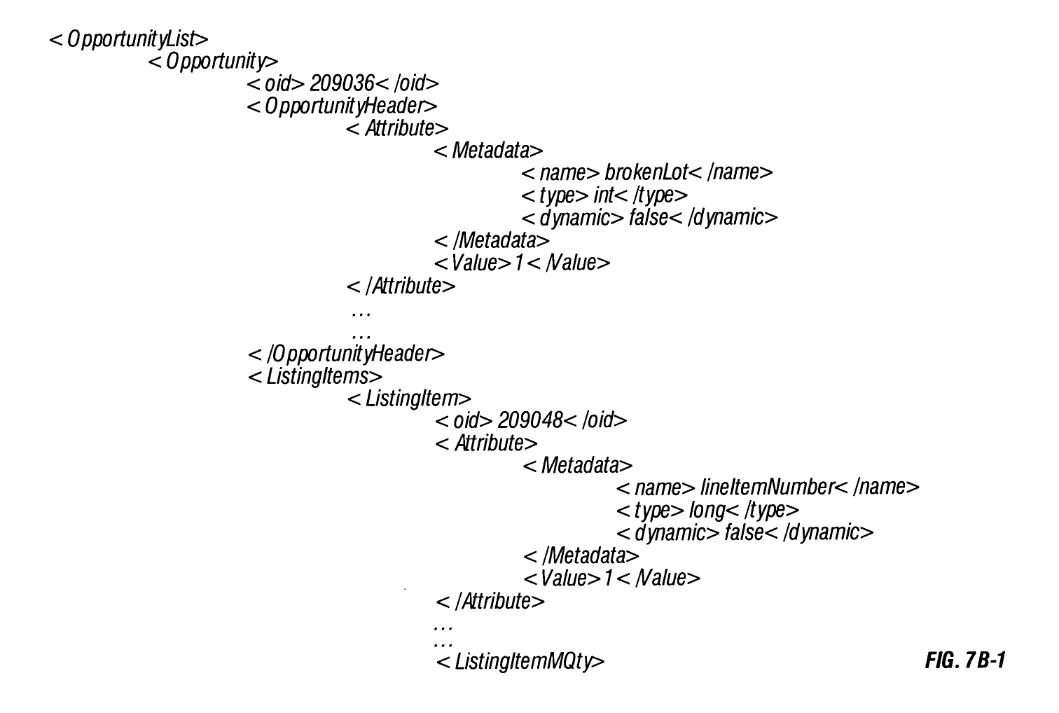

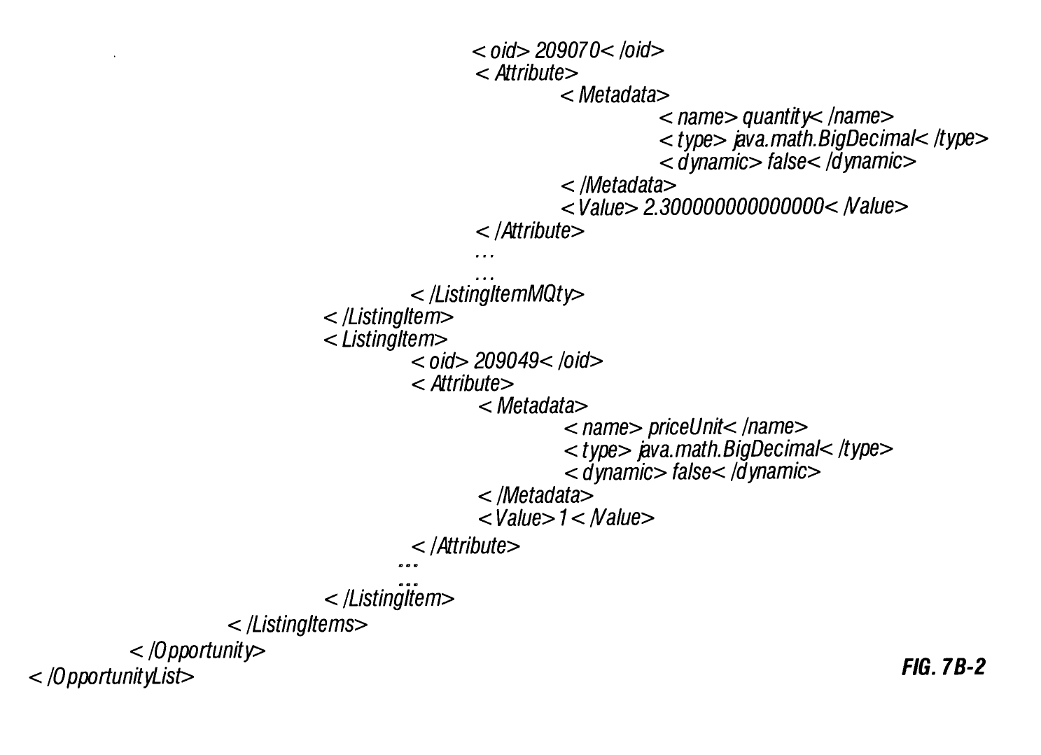

The output of the Construct Opportunity sequence, Construct XML sequence, and the To XML sequence is an XML file with opportunity data formatted so that it may be accessed by external applications compatible with XML files. FIG. 7A shows an example of a portion of an XML file including generalized data for a static attribute with the name “brokenLot,” with a data type equal to integer, and with a value of one. FIG. 7B illustrates the relationship of the brokenLot attribute as well. Although the example in FIGS. 7A and 7B show XML format, other generalized data formats may be used.

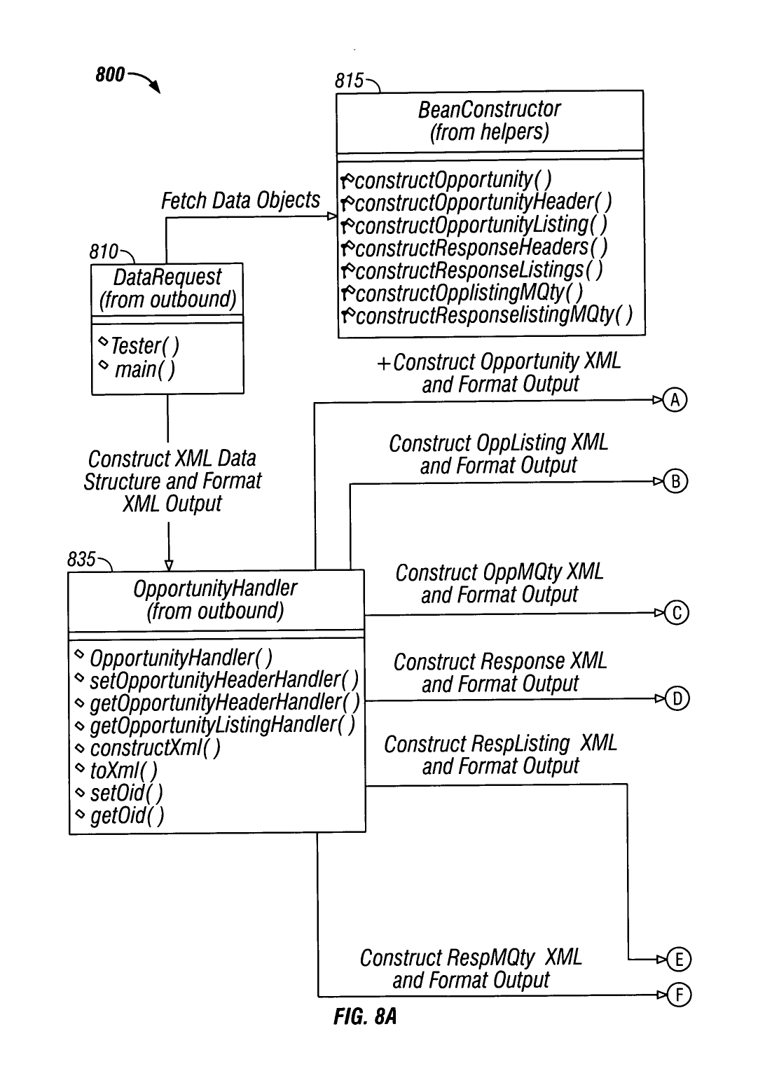

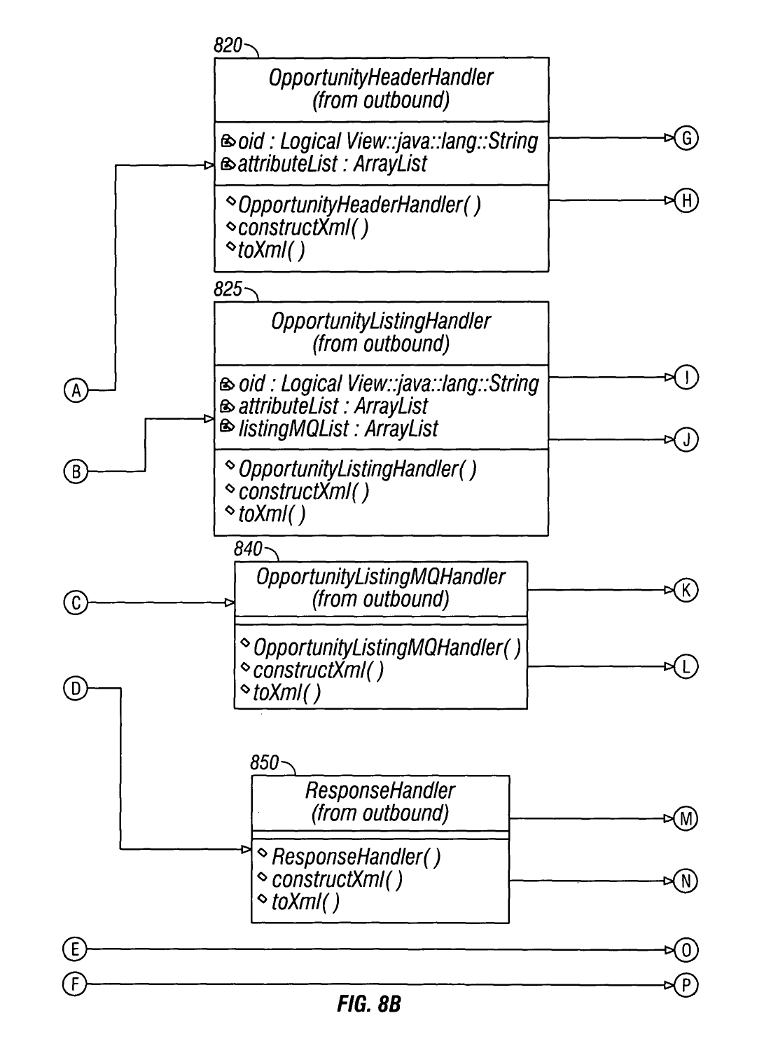

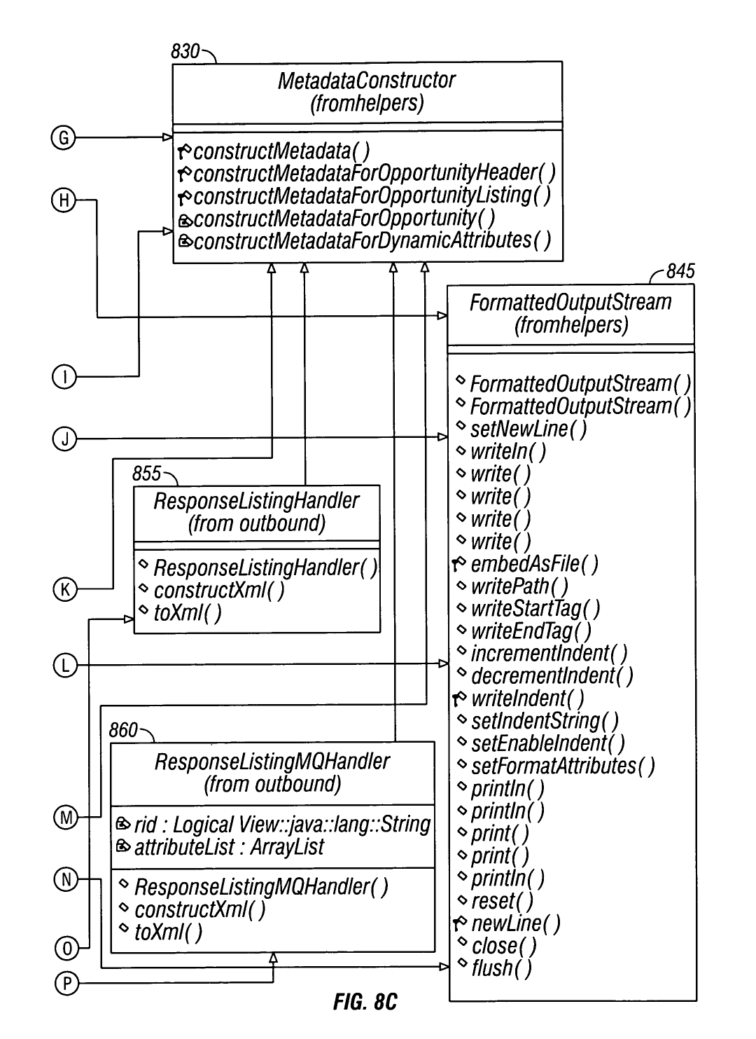

FIG. 8 shows class diagrams for a generalized data handler 800. Handler 800 includes a DataRequest class 810, a BeanConstructor class 815, an OpportunityHeaderHandler class 820, an OpportunityListingHandler class 825, a MetadataConstructor class 830, an OpportunityHandler class 835, an OpportunityListingMQHandler class 840, a FormattedOutputStream class 845, a ResponseHandler class 850, a ResponseListingHandler class 855, and a ResponseListingMQHandler class 860.

Dynamic Bidding Tool

The following is a description of a dynamic bidding tool that may be used with a generalized data handler such as handler 800 of FIG. 8. The dynamic bidding tool may be implemented in a number of ways. It may be implemented so that potential participants are registered with the system before they can participate in commercial activities using the system. Alternately, it may be implemented so that some participants are registered with the system, while others may access and participate in commercial activities through a public venue, such as a public portal.

In an implementation, the dynamic system is a web-based dynamic bidding tool that provides parties with the ability to submit requests for information (RFIs), requests for quotation (RFQs), and to run auctions such as reverse auctions. The dynamic bidding tool may be implemented in a computer system including one or more computers that may be connected via a computer network. A user of the dynamic bidding tool may be a purchasing agent who needs to purchase one or more products, components or services or may be a supplier of one or more products/services. In order to initiate or respond to an RFQ, RFI, or reverse auction, the user may first log onto the dynamic bidding tool.

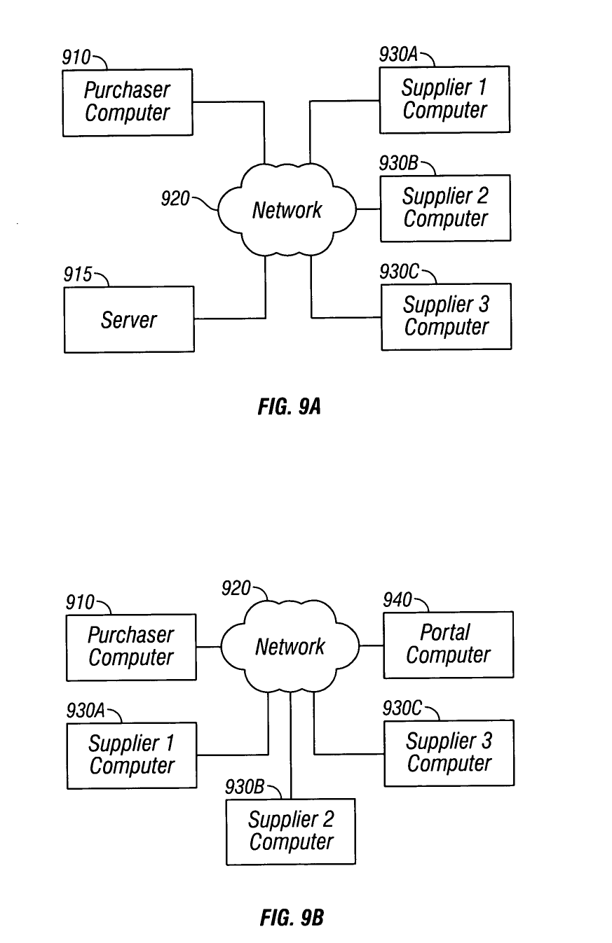

In an implementation of a dynamic bidding tool, the tool is stored on one or more computer systems, and may be accessed by users through a computer network. For example, a purchasing agent or other person may access the dynamic bidding tool on a local computer, or on a remote computer via a network. FIG. 9A shows an implementation where at least a portion of a dynamic bidding tool is stored on a purchaser computer 910, a server 915, and/or supplier computers 930A-930C. Purchaser computer 910 and/or supplier computers 930A-930C may access server 915 directly or via a network 920.

A user, such as a purchasing agent, uses the dynamic bidding tool to create opportunities. Opportunity data is then stored on, for example, server 915. Purchaser computer 900 is configured to communicate with supplier computers 930A, 930B, and 930C over network 920. Supplier computers 930A, 930B, and 930C may include at least a portion of the dynamic bidding tool. Note that although one purchaser computer 910 and three supplier computers 930A, 930B, and 930C are shown here, different numbers of each type of computer may be used. Further, a company that is a supplier of one particular product/service may be a purchaser of another product/service.

FIG. 9B shows an implementation in which purchaser computer 910 may interact with supplier computers 930A, 930B, and 930C via a portal computer 940 over a network 920. The network may include one or more local area networks (LANs), one or more metropolitan area networks (MANs), one or more wide area networks (WANs), one or more enterprise networks, one or more virtual private networks (VPNs), or another network such as the Internet.

Some or all of a generalized data handler such as handler 800 of FIG. 8 may be stored on, for example, purchaser computer 910, server 915, portal computer 940, or one or more of supplier computers 930A-930C. Handler 800 accesses stored business object data (for example, business object data stored in one or more database tables on server 915) to export the business object data to an external application, such as a purchaser or supplier ERP application.

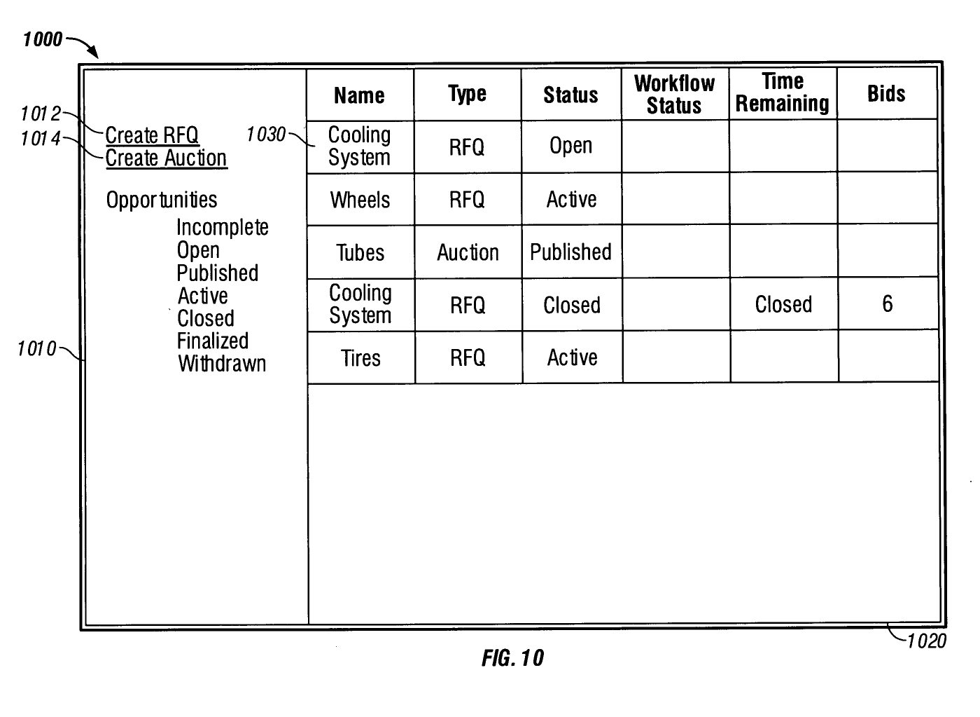

FIG. 10 shows an implementation of a user interface 1000 for a dynamic bidding tool that may be presented to a user via a display after the user accesses the dynamic bidding tool. Interface 1000 may include a first area 1010 and a second area 1020. First area 1010 includes user-selectable navigation items such as a “create RFQ” item 1012, and a “create auction” item 1014. In response to user selection of a navigation item, the computer system provides a user interface related to that navigation item.

When a user initially accesses the dynamic bidding tool, second area 1020 may show a summary of the opportunities that have been created by the user, including an opportunity 1030. Opportunity 1030 has an opportunity name equal to “Cooling System,” an opportunity type equal to RFQ, and an opportunity status equal to “Open.” Opportunity 1030 may also include a workflow status column, a time remaining column, and a bids column. Other columns may be included to present opportunity-related information to the user.

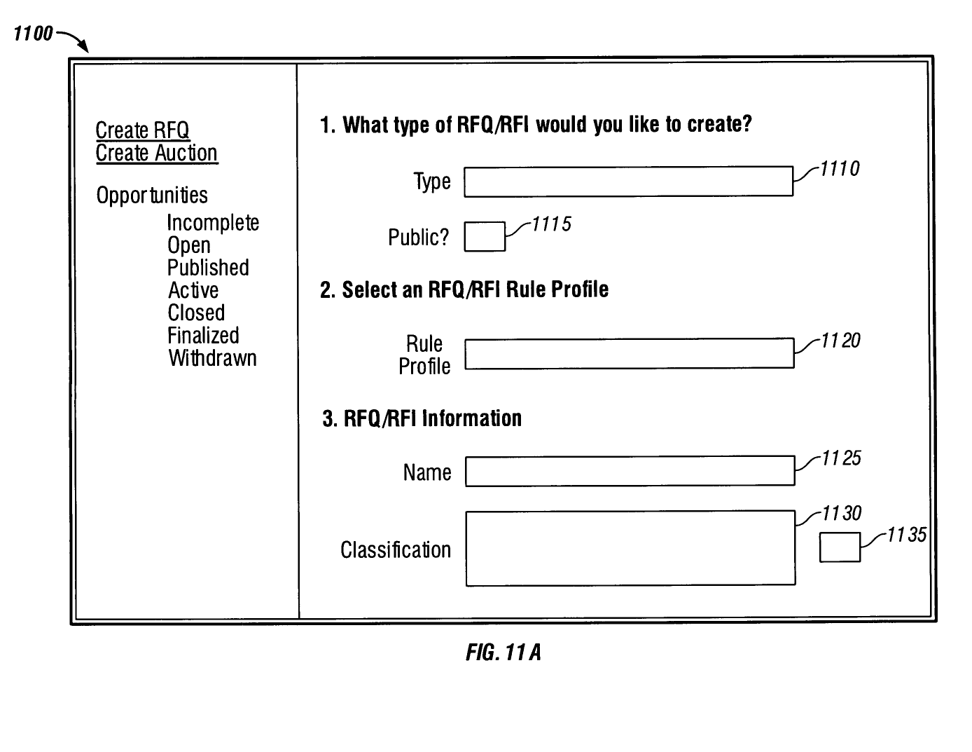

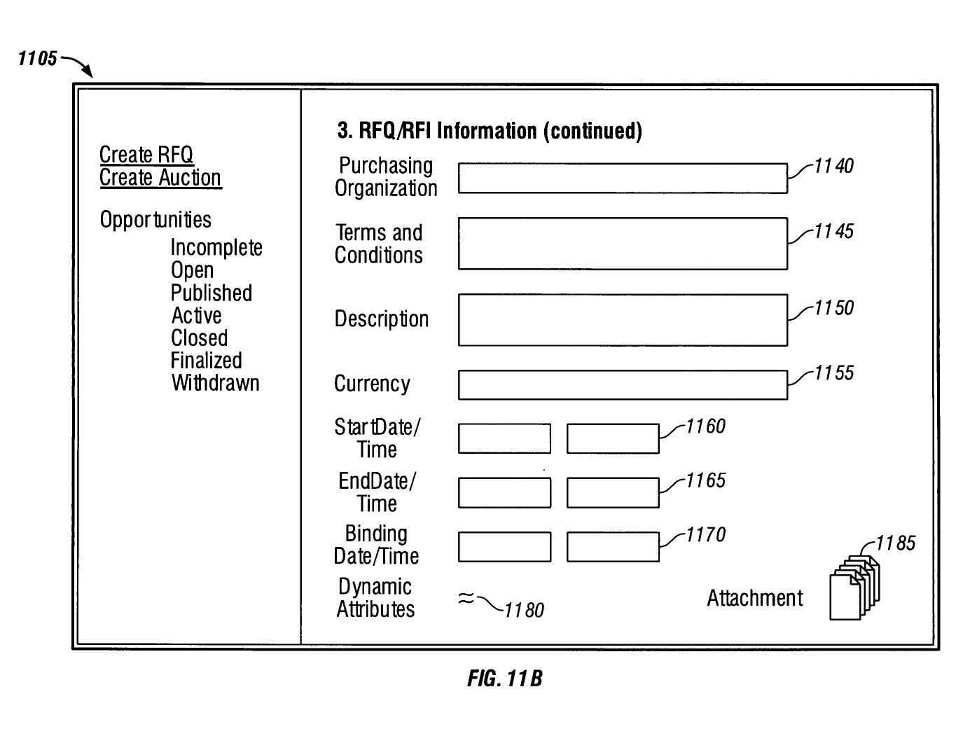

The user may choose to create an RFQ by selecting the “create an RFQ” item in first area 1010. FIGS. 11A and 11B show an implementation of a user interface 1100 for creating an opportunity with an opportunity type of RFQ that may be subsequently presented to the user. A user may enter an RFQ/RFI type in an area 1110, and may choose whether the RFQ will be a public opportunity by selecting/deselecting a checkbox 1115. Note that in different implementations, different field types and data entry methods may be enabled. For example, some fields may allow data entry using text boxes, check boxes, and drop-down menu selections.

A user may choose an RFQ/RFI rule profile in area 1120. For example, the user may select a particular rule profile from a drop-down list of available rule profiles. The rule profile includes one or more rules that govern the operation of the opportunity. In some implementations, the user may select individual rules as well as or instead of selecting rule profiles. In some implementations, users can create rules and/or rule profiles to govern the operation of one or more opportunities.

Opportunity rules may govern whether a potential supplier may submit bids for less than the full desired quantity, and whether a potential supplier may submit bids for fewer than all of the line items in the opportunity. Rules may determine whether an RFQ has a starting price, whether the opportunity has a set closing date and time, whether sealed bidding is allowed, whether anonymous bidding is allowed, whether the opportunity closing date and time may be extended due to activity near the scheduled closing, and/or whether the responses will be ranked based on the price quoted.

In some implementations, opportunity rules may be used to automate the process of validating bids and bidders. In a particular situation, not all potential suppliers may be equal. For example, a purchaser may have an preferred supplier list, an approved supplier list, a secondary supplier list, may place suppliers in different groups, or may rate suppliers individually. Other rules may be implemented to implement other differences.

The user may name the opportunity in an area 1125. Additionally, the user may provide a classification for the opportunity in an area 1130. Alternately, the user may choose a classification from a list of classifications by choosing an icon 1135. The user may choose or enter a purchasing organization in an area 1140, and may choose or enter terms and conditions in an area 1145.

The user may enter a description in an area 1150, a currency in an area 1155, a start date/time in an area 1160, an end date/time in an area 1165, and a binding date/time in an area 1170. A user may create one or more dynamic attributes for the opportunity by selecting an icon 1180. One or more attachments can be associated with the opportunity using an attachment icon 1185. Note that the attachment feature is separate for convenience; associated attachments may be one type of dynamic attribute that may be associated with the dynamic attribute. In other implementations, more, different, and/or different options may be provided to the user.

After general opportunity data is provided, the user may enter one or more line items to be purchased according to the opportunity parameters. FIG. 12 shows a user interface 1200 that may be presented to the user and subsequently used to create a new line item for an opportunity.

The user may enter a name for the item to be sourced in an area 1210, and a desired quantity in an area 1215. The user may enter base unit data in an area 1220, category data in an area 1225, ship-by data in an area 1230, terms and conditions data in an area 1235, and a description in an area 1235. The user may create one or more dynamic attributes by choosing an icon 1245. Dynamic attributes are described more fully below. One or more attachments can be associated with the line item using an attachment icon 1250.

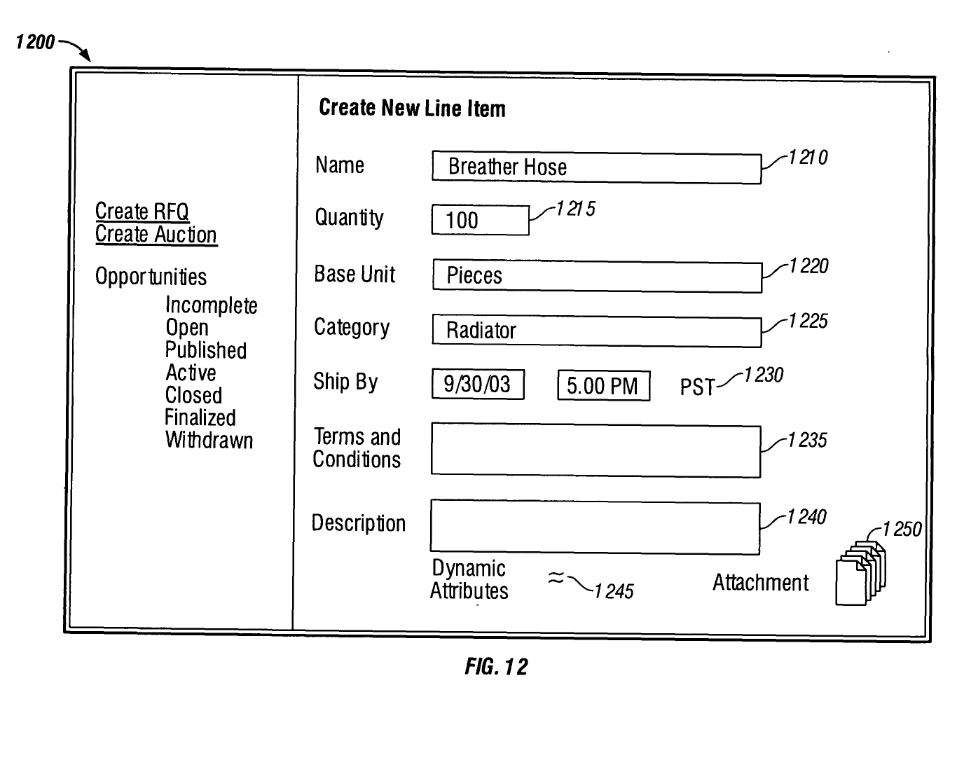

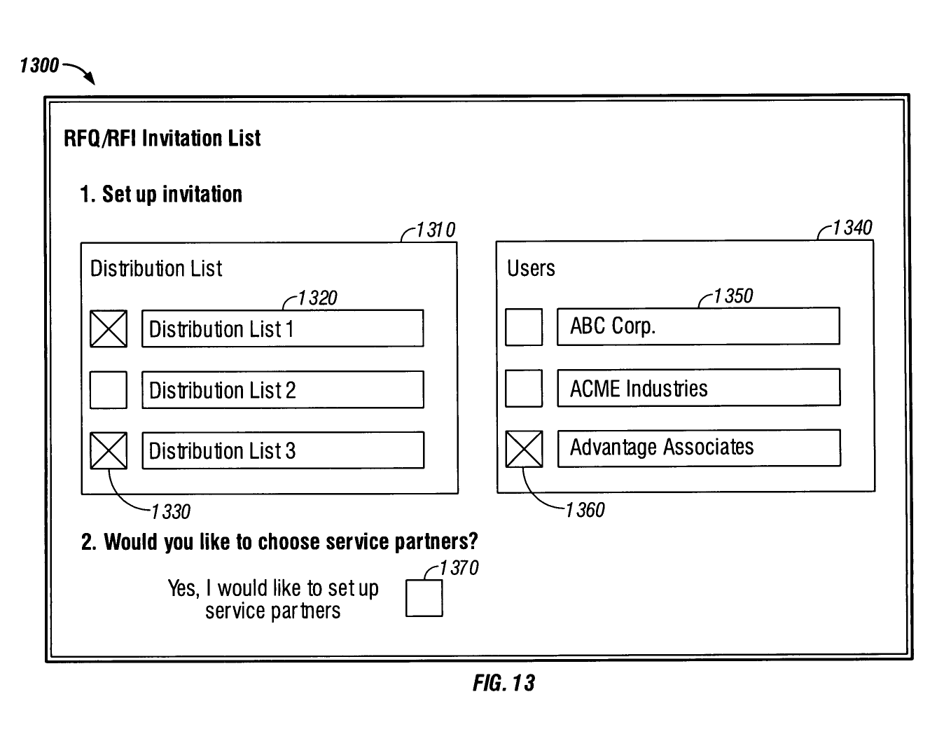

The user may select one or more potential suppliers to receive the opportunity. FIG. 13 shows a user interface 1300 for creating an invitation list for an opportunity. A user may select one or more distribution lists using an area 1310. In some implementations, a number of pre-determined distribution lists 1320 are presented to the user, who may select one or more of the lists using an appropriate checkbox 1330. A distribution list is generally a list of recipients related by a particular characteristic. For example, different distribution lists could include preferred suppliers of machined parts, secondary suppliers of machined parts, suppliers of specialty machined parts, and suppliers of machined ceramic parts. There may be overlap among the distribution lists. For example, one supplier of specialty machined parts may also be a preferred or secondary supplier of machined parts

The user may select one or more users using an area 1340. In some implementations, a number of pre-determined users 1350 are presented to the user, who may select one or more using the appropriate check box 1360. Users are generally individual recipients that may or may not be included in one or more distribution lists. For example, each of the machined parts suppliers on the distribution lists described above may be listed as available users. Providing the capability for choosing individual potential suppliers provides more flexibility for the purchaser.

The user may choose to set up service partners by selecting a checkbox 1370. Generally, service partners include preferred and/or contracted providers for services such as logistics and insurance. Providing the capability to choose service partners may lower the cost of the services to the purchaser/supplier, since rates for the services can be negotiated prior to the particular commercial transaction reflected in the opportunity.

An opportunity may be communicated to suppliers on the invitation list (and/or to one or more public portals if the opportunity is public) when the status of the opportunity is “published.” At this point, potential suppliers may be able to view opportunity details, but may not be able to respond to the opportunity. Potential suppliers may respond to the opportunity once the status has been changed to “active.”

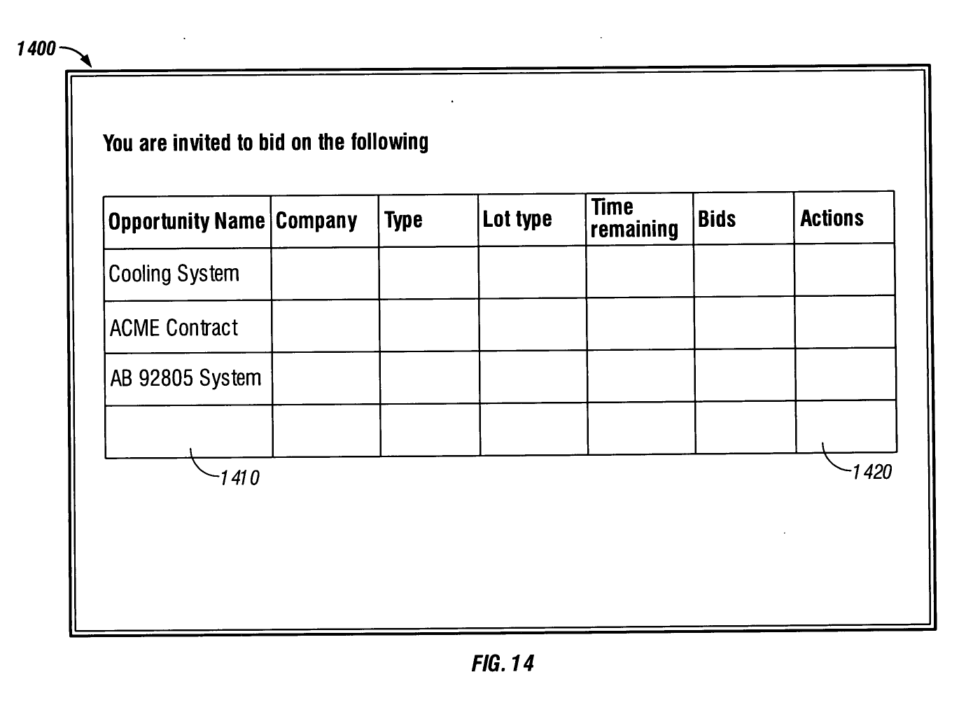

An opportunity can be communicated to a prospective supplier of a product via an email invitation to respond to the opportunity that includes a link to the opportunity. Alternately, the prospective supplier may log on to a dynamic bidding tool and access opportunities to which he has received an invitation. FIG. 14 shows a user interface 1400 that may be presented to potential suppliers for one or more opportunities. Interface 1400 includes a list 1410 of opportunities to which the supplier has been invited to submit a bid. Interface 1400 may display additional data about the opportunities, such as the company initiating the opportunity, the opportunity type, the lot type, the status, the time remaining, and the number of bids received. A supplier may bid on an opportunity by choosing a “create bid,” selection from a drop-down menu in an action column 1420.

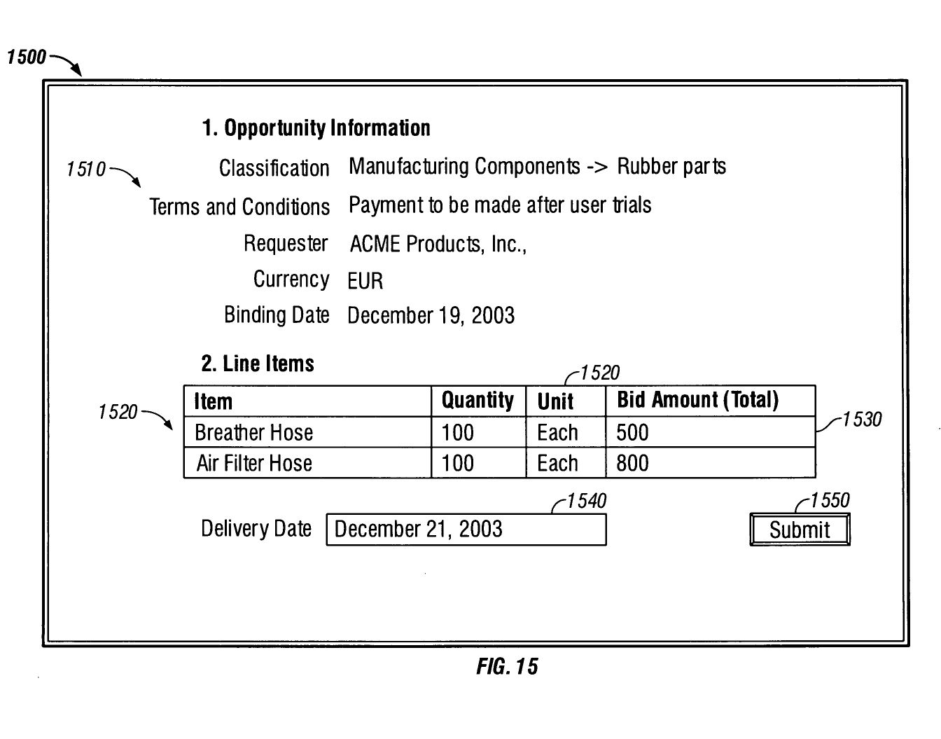

FIG. 15 shows a user interface 1510 for creating a response to opportunity. A first area 1510 includes details about the opportunity, such as the opportunity classification, terms and conditions, requester, currency, and binding date. Interface 1500 includes a second area 1520 with details about particular line items for the opportunity. For the example shown in FIG. 15, the opportunity rule profile was full/full (bids must be for the full quantity of each of the line items). Therefore, the supplier enters a total price in a box 1530. The supplier chooses a delivery date in an area 1540. The supplier selects a “submit bid” button 1550 to submit the bid.

Potential suppliers may submit bids in response to the opportunity while the status of the opportunity is active. The status of the opportunity may be changed to closed by the opportunity initiator, or by the system when the end date/time has been reached. Once the opportunity is closed, a winner may be determined.

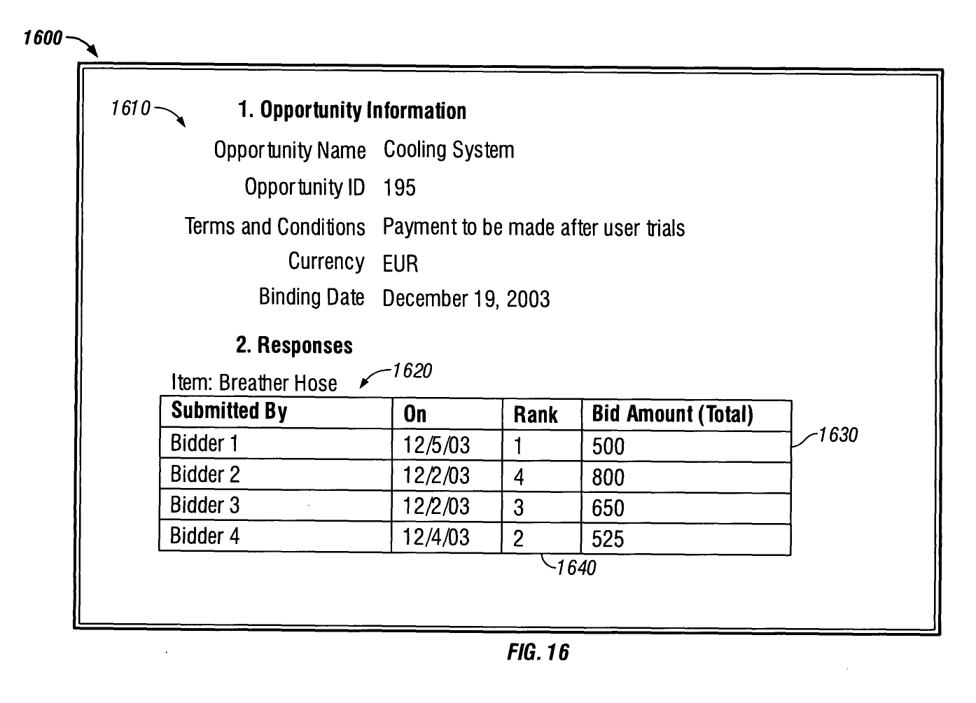

FIG. 16 shows a user interface 1600 that may be provided to the user for winner determination. Interface 1600 includes a first area 1610 with general information about the opportunity. Interface 1600 includes a second area 1620 including bid information for the opportunity. For example, second area 1620 may include information pertaining to a all bids submitted for the opportunity. The information may include a bid amount 1630 for each bidder, as well as a ranking 1640 for each bidder. Note that the ranking may be based on more than price. In some implementations, different response parameters may be given different weights, and the ranking may reflect this weighting. For example, if an item is particular difficult to obtain, a large quantity of the item may be assigned a substantial weight. In such a case, a bid offering (for example) 100 units at a unit price of $100 each may be ranked higher than a bid offering 70 units at a unit price of $80. Further, in some implementations, a user may select a winner based on bid information. In others, winner determination may be accomplished automatically.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although only a few embodiments have been described in detail above, other modifications are possible. Portions of this disclosure discuss a particular implementation of a dynamic bidding tool. Different implementations may be used. Additionally, different data structures may be used to determine a structure for the generalized data to be provided to the external application. In certain implementations, multitasking and parallel processing may be preferable.

Other embodiments may be within the scope of the following claims.

1. A method, comprising:
retrieving business object data from one or more database tables, the business object data including attribute data for one or more attributes of the business object;
retrieving metadata from the business object data, the metadata including a name, a data type, and a value for each attribute of the business object data;
constructing a generalized data structure for the attribute data using the metadata; and
parsing the attribute data into the generalized data structure.

2. The method of claim 1, further comprising:
receiving a request for business object data associated with a particular business object.

3. The method of claim 1, wherein retrieving business object data comprises retrieving opportunity header data and data for one or more opportunity listings.

4. The method of claim 3, wherein the business object data includes data related to a desired commercial transaction.

5. The method of claim 4, wherein the opportunity header data includes an opportunity type and an opportunity identifier.

6. The method of claim 4, wherein the data for one or more opportunity listings includes product data, the product data associated with a product to be obtained as a result of the desired commercial transaction.

7. The method of claim 4, wherein the data for one or more opportunity listings includes service data, the service data associated with a service to be obtained as a result of the desired commercial transaction.

8. The method of claim 3, wherein retrieving business object data comprises retrieving response data associated with the one or more opportunity listings.

9. The method of claim 8, wherein the response data includes a bid amount corresponding to one or the one or more opportunity listings.

10. The method of claim 1, wherein retrieving business object data from the one or more database tables includes executing one or more series query language statements according to a persistence layer implementation.

11. The method of claim 1, wherein the attribute data includes data for a first set of static attributes and a first set of dynamic attributes.

12. The method of claim 1, wherein the generalized data structure conforms to extensible markup language (XML) format.

13. The method of claim 1, further comprising communicating the attribute data in the generalized data structure to an external application.

14. An article comprising a machine-readable medium storing instructions operable to cause one or more machines to perform operations comprising:
retrieving business object data from one or more database tables, the business object data including attribute data for one or more attributes of the business object;
retrieving metadata from the business object data, the metadata including a name, a data type, and a value for each attribute of the business object data;
constructing a generalized data structure for the attribute data using the metadata; and
parsing the attribute data into the generalized data structure.

15. The article of claim 14, further comprising:
receiving a request for business object data associated with a particular business object.

16. The article of claim 14, wherein retrieving business object data comprises retrieving opportunity header data and data for one or more opportunity listings.

17. The article of claim 16, wherein the business object data includes data related to a desired commercial transaction.

18. The article of claim 17, wherein the opportunity header data includes an opportunity type and an opportunity identifier.

19. The article of claim 17, wherein the data for one or more opportunity listings includes product data, the product data associated with a product to be obtained as a result of the desired commercial transaction.

20. The article of claim 17, wherein the data for one or more opportunity listings includes service data, the service data associated with a service to be obtained as a result of the desired commercial transaction.

21. The article of claim 16, wherein retrieving business object data comprises retrieving response data associated with the one or more opportunity listings.

22. The article of claim 21, wherein the response data includes a bid amount corresponding to one of the one or more opportunity listings.

23. The article of claim 14, wherein retrieving business object data from the one or more database tables includes executing one or more series query language statements according to a persistence layer implementation.

24. The article of claim 14, wherein the attribute data includes data for a first set of static attributes and a first set of dynamic attributes.

25. The article of claim 14, wherein the generalized data structure conforms to extensible markup language (XML) format.

26. The method of claim 14, further comprising communicating the attribute data in the generalized data structure to an external application.

27. A system, comprising:
means for storing business object data for a plurality of business objects in one or more database tables;
means for retrieving particular business object data associated with a particular business object from the one or more database tables, the particular business object data including attribute data for one or more attributes of the particular business object;
means for retrieving metadata from the particular business object data, the metadata including a name, a data type, and a value for each attribute of the particular business object data;
means for constructing a generalized data structure for the attribute data using the metadata; and
means for parsing the attribute data into the generalized data structure.

28. The system of claim 27, further comprising:
means for identifying the particular business object.

29. The system of claim 27, wherein the means for retrieving business object data comprises means for retrieving opportunity header data and data for one or more opportunity listings.

30. The system of claim 29, wherein the means for retrieving business object data comprises means for retrieving response data associated with the one or more opportunity listings.

31. The system of claim 27, further comprising means for communicating the attribute data in the generalized data structure to an external application.

32. The system of claim 27, wherein the generalized data structure conforms to XML format.
